(19) United States
(12) Patent Application Publication
(10) Pub. No.: US 2014/0074689 A1
(43) Pub. Date: Mar. 13, 2014

(54) Systems and Methods for Modifying Consumer Credit Data

(71) Applicants: Kristian Lund, St. Louis Park, MN (US); Matthew Briggs, Santa Barbara, CA (US); Darryl Eaton, Santa Barbara, CA (US)

(72) Inventors: Kristian Lund, St. Louis Park, MN (US); Matthew Briggs, Santa Barbara, CA (US); Darryl Eaton, Santa Barbara, CA (US)

(21) Appl. No.: 14/025,823

(22) Filed: Sep. 12, 2013

Related U.S. Application Data
(60) Provisional application No. 61/700,267, filed on Sep. 12, 2012.

(51) Int. Cl. G06Q 40/02

(52) U.S. Cl. CPC G06Q 40/025
USPC 705/38

(57) ABSTRACT

Aspects of the present invention include methods and systems useful for modifying a consumer's credit data. This can be achieved by receiving and analyzing consumer data and a credit goal of the consumer. A simulation can be performed, simulating one or more changes to tradeline data of the consumer and determining if the simulation achieves the at least one credit goal of the consumer. If so, an action plan can be generated, including one or more steps for the consumer to carry out to achieve the at least one credit goal. Credit tradeline data of the consumer can be monitored, and from the observed data, it can be determined if the at least one credit goal has been achieved. If so, aspects of the invention can include notifying a lender that the at least one goal has been achieved.

### CROSS-REFERENCES

This application claims the benefit of U.S. Provisional Application No. 61/700,267, filed Sep. 12, 2012, the content of which is hereby incorporated by reference in its entirety.

### BACKGROUND

There are multiple situations in which a consumer may wish to apply for credit. However, as is known, not all consumers can qualify for every credit product available, and in some cases they may be turned down or denied credit. Consumers in these cases intended and were motivated to make an acquisition requiring credit, but were unable to or unable to achieve desirable terms. Consumers are typically frustrated, confused on why they were denied credit or maybe even unaware of information that exists that was the cause of their denial.

### SUMMARY

Some aspects of the present invention are generally related to a method for modifying a consumer's credit data. The method can include receiving consumer data identifying a consumer and at least one credit goal with processing circuitry. The method can also include using the consumer data to retrieve, with the processing circuitry, credit tradeline data associated with at least one credit tradeline of the consumer. The processing circuitry can simulate one or more changes to the credit tradeline data to generate a corresponding simulation and determine whether the simulation achieves the at least one credit goal of the consumer. The method can further include generate an action plan including one or more steps for the consumer to achieve the at least one credit goal. The one or more steps of the action plan can include making changes corresponding to the simulation if the simulation achieves at least one credit goal.

Embodiments of the invention can include using a credit processing system to generate an enrollment interface configured to receive consumer data. The credit processing system can transmit the enrollment interface for display to a user. The transmitting of the enrollment interface can be associated with an undesirable credit event with a lender, such as the denial of credit. The credit processing system can receive the consumer data and at least one credit goal associated with the undesirable credit event from the enrollment interface. The credit goal can include a transformation of the undesirable credit event to a desirable credit event, such as being granted credit, for example. The credit processing system can use the consumer data to retrieve credit tradeline data for the consumer associated with at least one credit tradeline of the consumer. The credit processing system can simulate one or more changes to the credit tradeline to generate a corresponding simulation, and determine whether the simulation achieves at least one credit goal.

The credit processing system can generate an action plan that includes one or more steps for the consumer to achieve at least one credit goal, such as making the one or more changes corresponding to the simulation if the simulation achieves at least one credit goal. The credit tradeline data can be monitored with the credit processing system, which can detect if the at least one credit goal has been achieved. If so, the credit processing system can notify the lender that the at least one goal has been achieved.

Aspects of the invention also include a credit processing system including processing circuitry having one or more processors and memory. The memory can include instructions that can be executed by the processors and cause the processors to carry out any or all of the steps outlined above.

Some embodiments of the present invention may optionally provide none, some, or all of the following advantages, though other advantages not listed here may also be provided. In some embodiments, methods and systems of the invention can use a consumer's credit tradeline data and credit goals to simulate the impact of changes to the tradeline data. Based on the simulated changes, it can be determined whether or not the simulated changes can achieve the consumer's credit goal(s). If so, an action plan can be generated setting forth steps for the consumer to undertake in order to achieve the goal(s).

Performing a simulation of changes to tradeline data and determining whether or not such changes can work to achieve the credit goal(s) of the consumer allows the consumer to predict the outcome of any changes before they are actually made. This can assist a consumer in achieving his or her credit goals in a direct and efficient manner. The system and/or method can include notifying a lender if a credit goal has been achieved, possibly expediting the change of an undesirable credit event to a desirable one.

For example, if a consumer is denied an application for credit because of a low credit score, a goal can be established to improve the consumer's credit score sufficiently to be granted credit. A simulation can be performed to determine the effect of, for example, lowering a credit account balance and/or increasing the amount of credit available to the consumer. The simulation can be used to determine which, if any, actions by the user can be undertaken to sufficiently improve his or her credit score. In some embodiments, the system can at least partially complete a step in the action plan on behalf of the consumer, such as lowering a credit balance. The consumer's credit score can be monitored and a sufficient improvement in the credit score can be detected. A lender can be notified that the consumer's credit goal has been achieved.

Various credit goals can include buying a house, buying a car, consolidating credit accounts, lowering a credit account balance, lowering a credit account payment, building a positive credit profile, and protecting the consumer's credit. Aspects of the present invention can assist a user in achieving such credit goals by simulating various changes in the consumer's credit tradeline data and determining if the changes can result in achieving the goal. An action plan can be set forth in accordance with a successful simulation to assist the user in achieving the goals.

These and various other features and advantages will be apparent from a reading of the following detailed description.

### BRIEF DESCRIPTION OF THE DRAWINGS

The following drawings illustrate some particular embodiments of the present invention and therefore do not limit the scope of the invention. The drawings are not to scale (unless so stated) and are intended for use in conjunction with the explanations in the following detailed description. Some embodiments will hereinafter be described in conjunction with the appended drawings, wherein like numerals denote like elements.

FIG. 1 is a high level process flow diagram illustrating an end-to-end process for the automation of capture to reconnect according to some embodiments of the invention.

FIG. 2 displays a variety of points of entry (including manual/automated inputs and inputs integral to a particular enrollment process) based on the specific situation for a consumer according to some embodiments of the invention.

FIG. 3 is a flow diagram providing an overview of the steps involved in Enrollment according to some embodiments of the invention.

FIG. 4 depicts an enrollment interface displaying a Collect Applicant Data screen according to some embodiments of the invention.

FIG. 5A depicts an interface displaying a letter to print to hand to a consumer with instructions for enrolling in a credit processing system according to some embodiments of the invention.

FIG. 5B depicts an interface displaying an email sent to a consumer with instructions for enrolling in a credit processing system according to some embodiments of the invention.

FIG. 6 depicts a system interface that validates an email address to confirm identity with consumer data such as a password, date of birth, and consent to terms of service according to some embodiments of the invention.

FIG. 7 depicts a fraud prevention system interface to validate identity based on a variety of “Out of Wallet” questions based on information not likely obtained with fraud or stolen identity according to some embodiments of the invention.

FIG. 8 is a process flow diagram illustrating a Consumer Enrollment Process with ‘Coaching’ to allow for a lender or sales staff to collaborate with consumers according to some embodiments of the invention.

FIG. 9 depicts a system interface displaying with consumer acceptance of terms for viewing by a consumer while at dealership to view an action plan together with the dealer according to some embodiments of the invention.

FIG. 10 depicts a system interface with exemplary “Out of Wallet” questions a consumer can answer while at a dealership according to some embodiments of the invention.

FIG. 11 depicts a system coaching interface showing an action plan (similar to a consumer action plan interface) and ability to simulate in addition to steps to achieve target credit score/tier goal according to some embodiments of the invention.

FIG. 12 depicts a system interface showing possible goals or targets for a consumer to choose from according to some embodiments of the invention.

FIG. 13 depicts a system interface showing data to provide a tabular, graphical or other view of interest rates by credit score range according to some embodiments of the invention.

FIG. 14 depicts a system pre-qualification interface for a consumer according to some embodiments of the invention.

FIG. 15 is a process flow diagram illustrating process and data flow between a user interface and other system components according to some embodiments of the invention.

FIG. 16 depicts simulation results using a binary search method to build a Utilization Curve according to some embodiments of the invention.

FIG. 17 is a process flow diagram illustrating process and data flow between various system elements when implementing a Personalized Action Plan according to some embodiments of the invention.

FIG. 18 depicts a system interface showing an Applicant Dashboard in which an applicant can see a credit score and simulation according to some embodiments of the invention.

FIG. 19 depicts a system interface showing an example of an Action Plan with specific executable action plan steps according to some embodiments of the invention.

FIG. 20 depicts a system interface showing one or more actionable steps that can be taken by a user according to some embodiments of the invention.

FIG. 21 depicts a system interface showing an action completed status after a user performs one of the steps according to some embodiments of the invention.

FIG. 22 depicts a system interface illustrating incentives a consumer can receive for completing a certain actionable step according to some embodiments of the invention.

FIG. 23 shows a process flow diagram illustrating an exemplary Monitoring configuration and results of events occurring while monitoring according to some embodiments of the invention.

FIG. 24 depicts a system interface for showing a consumer benefits and implications of monitoring credit according to some embodiments of the invention.

FIG. 25 depicts a system interface showing a list of parameters that can be used to set notifications and alerts for some potential risks to a credit score according to some embodiments of the invention.

FIG. 26 depicts a system interface showing a dealer view according to some embodiments of the invention.

FIG. 27 is a high-level block diagram of a credit processing system according to some embodiments of the invention.

FIG. 28 illustrates a flow process for applying a credit processing system during an auto sales cycle and auto post-sales cycle according to some embodiments of the invention.

FIG. 29 is high level process flow diagram illustrating a credit processing system integrated within a lender scenario, in this case an automobile dealer, according to some embodiments of the invention.

FIG. 30 illustrates data movement within a credit processing system according to some embodiments of the invention.

FIG. 31A is a process-flow diagram illustrating steps of a credit threshold simulation including a dealer simulation according to some embodiments of the invention.

FIG. 31B is a process-flow diagram illustrating steps of a credit threshold simulation according to some embodiments of the invention.

FIG. 32 is a process-flow diagram outlining Dealer Simulation & Consumer Review steps according to some embodiments of the invention.

FIG. 33 is a process-flow diagram outlining steps in a High Level Tenant Credit Process, from End to end, with flow beginning at enrollment according to some embodiments of the invention.

FIG. 34 is a system block-flow diagram illustrating a process of modifying consumer credit data within a rental scenario according to some embodiments of the invention.

FIG. 35 is an exemplary system block-flow diagram illustrating applicant and landlord connections within a rental scenario according to some embodiments of the invention.

FIG. 36 is a process flow diagram outlining a High Level Landlord Credit Process according to some embodiments of the invention.

FIG. 37 is a process flow diagram outlining a Frictionless Onboarding process as included in the credit process of FIG. 36.

FIG. 38 is a table showing an example of what an applicant would see for the property or set of properties they were applying for.

### DETAILED DESCRIPTION

The following detailed description is exemplary in nature and is not intended to limit the scope, applicability, or configuration of the invention in any way. Rather, the following description provides some practical illustrations for implementing some embodiments of the invention. Examples of hardware configurations, systems, processing circuitry, data types, programming methodologies and languages, communication protocols, and the like are provided for selected aspects of the described embodiments, and all other aspects employ that which is known to those of ordinary skill in the art. Those skilled in the art will recognize that many of the noted examples have a variety of suitable alternatives.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Embodiments of the invention are generally directed to systems and methods that simulate changes to a consumer's credit profile in order to determine what type of actions may lead to achieving a credit goal set by the consumer or another party. According to some embodiments, a credit processing system and/or a method may implement a method of modifying consumer credit data in order to achieve various credit goals. As will be discussed, in some cases the foregoing is practices in the context of transforming a negative credit event into a positive credit event. In some cases this is referred to herein as “closing the loop” on a credit transaction and/or implementing a “capture to reconnect” process to keep a consumer in contact with and/or connect them with a new lender despite the earlier negative credit event.

Various embodiments of methods and systems described herein may also be used for partial and/or full automation of monitoring, modeling, simulation and engagement for transaction recapture are disclosed. Disclosed in various embodiments is a consumer product that may be placed at the point of rejection. One embodiment discloses various systems and automated methods to transform a credit decline into a prequalified buyer for businesses that may require lending for a majority of their transactions.

According to some embodiments, a credit processing system and/or method implementing aspects of the invention can provide several advantages and features. For example, as of now, there is not another system that automates the process of capturing consumers at time of rejection or offer of less than favorable terms. As further explained, automating the capture at the point of decline can accomplish multiple objectives and address the following failure points in today's process:

Customers intended and were motivated to make an acquisition requiring credit, but were unable to or unable to achieve desirable terms. By not stopping the process at the point of rejection, and instead turning the adverse event into an opportunity for both the consumer and lender this system captures that motivation and channels it into a closed loop process.

Consumers are typically frustrated, confused on why they were denied credit or maybe even unaware of information that exists that was the cause of their denial. By providing transparency into credit and credit history, then education on how each credit account and type positively and negatively influence credit.

Existing explanations as required by the FCRA (and CFPB) are insufficient and provide little clarity, and it is requires the consumer to pursue this information, potential from a variety of disparate sources. Consumer now doesn't need to pursue all of this information from multiple sources.

Finally, giving the denied consumer clear steps to accomplish their goal, providing support and automation for those steps removes the final hurdle between the consumer from accomplishing their goal thus closing the loop when the goal is reached.

### IMPLEMENTATION OF EMBODIMENTS

As will be appreciated, in describing various embodiments of the invention, many aspects of the embodiments are discussed in terms of functionality, in order to more particularly emphasize their implementation independence. Embodiments of the invention may be implemented using a combination of hardware, firmware, and/or software. For example, in many cases some or all of the functionality provided by embodiments of the invention may be implemented in executable software instructions capable of being carried on a programmable computer processor. Likewise, some embodiments of the invention include a computer-readable storage medium on which such executable software instructions are stored. Some embodiments of the invention may further be implemented upon or incorporated into personal computing devices, such as desktop or laptop computers, personal digital assistants (PDAs), mobile telephones, smart phones, tablet computers, and the like.

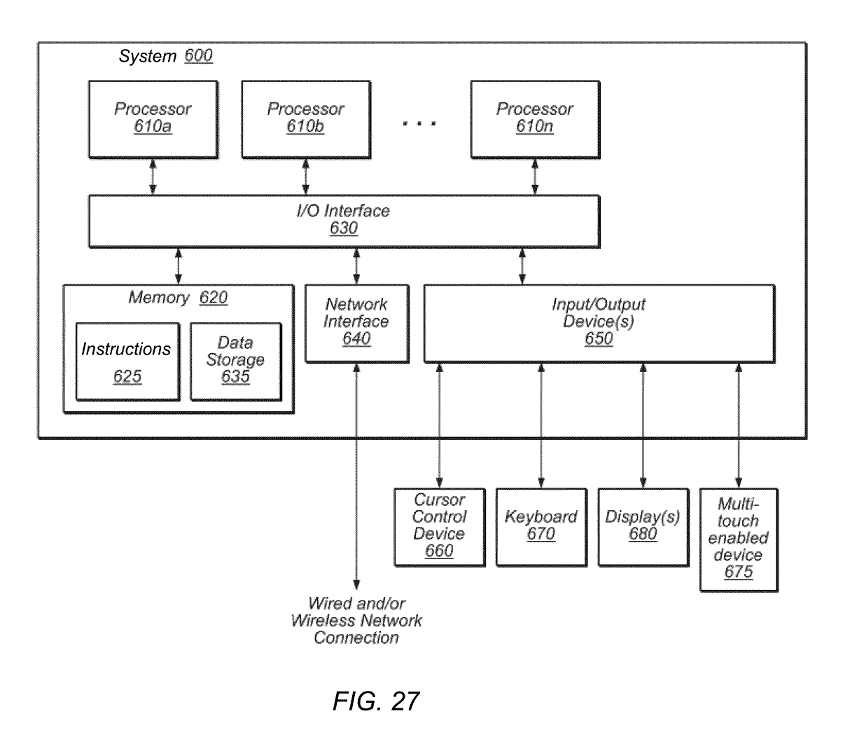

FIG. 27 shows a high-level block diagram of a credit processing system 600 according to some embodiments of the invention, which will be discussed in more detail hereinafter. Such a system 600 may also carry out methods of the invention in some embodiments.

Some embodiments of the invention provide credit processing systems and/or methods of processing consumer credit data that are designed to automate, combine and close a normally open-ended credit transaction that may terminate with a negative credit event such as a credit application denial or an offer of less desirable terms than originally expected. Some embodiments of the invention advantageously provide the ability to close the credit transaction loop even after such a negative credit event, thus leading to a higher likelihood that the credit transaction will succeed. Some embodiments provide the ability to overcome a negative credit event through the use of one or more of education, personalized action plans, incentives, and monitoring to achieve the consumer's goal of transforming the negative credit event into a positive credit event. Some embodiments also provide the ability to maintain a connection between a consumer and an original lender or reconnect the two once the consumer's credit goal has been achieved.

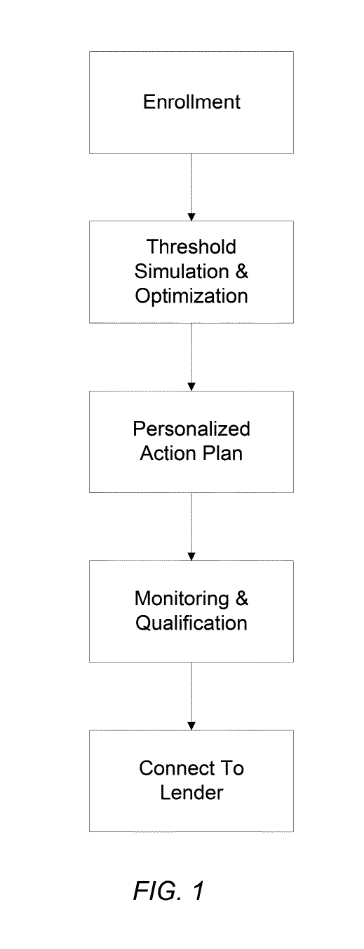

FIG. 1 is a high level process flow diagram illustrating an end-to-end process for modifying a consumer's credit data or credit scenario through the use of a personalized action plan, among other items. The process begins with enrollment of the consumer into the process and/or a credit processing system administering the process. As mentioned above and will be described in more detail below, in some cases this point of consumer enrollment can be associated with a negative credit event that the consumer has experience. After enrolling the consumer, a threshold simulation and optimization stage is entered in which the consumer's credit goals are evaluated against the consumer's actual credit tradeline data, such as credit data that is available from the major credit bureaus. The end result of this stage contributes to the generation of a personalized action plan that includes a number of steps for the consumer to follow to achieve his or her credit goals. In some cases the process can be partially or wholly automated to assist the consumer in completing the action plan. The process also includes monitoring the credit data for the consumer to determine if and when the consumer has achieved the credit goal, and then connecting the consumer with a lender offering one or more credit products. The lender may be the original lender associated with the negative credit event, or may possibly be a different lender. The following is a summary of the steps of the process in FIG. 1, including several sub-steps according to some embodiments.

Enrollment
Prequalification
Declined Financing
Offered less than favorable terms or risk based pricing
Refinance existing
Goal setting
Other channels
   E.g., Members of other services; RentTrack Process, etc.

Threshold

Simulation & Optimization
Qualify Potential
Coaching
Additional goal setting

Personalized Action Plan
Optimized step by step plan to reach goal
Automated action steps
Incentivizes
InstaScore process execution

Monitoring & Qualification
Triggers on all tradeline attributes changes

Connect To Lender
Reconnect to existing dealer
Connect to a different dealer
Connect to Goal target

Following is a further discussion of several aspects of the steps noted above and in FIG. 1 according to some embodiments.

Enrollment Procedure—

Multiple capture points can provide a point of entry for starting the enrollment process. Exposure to the process can be manual or automated, and may be integral with the enrollment process based on the specific situation for a consumer.

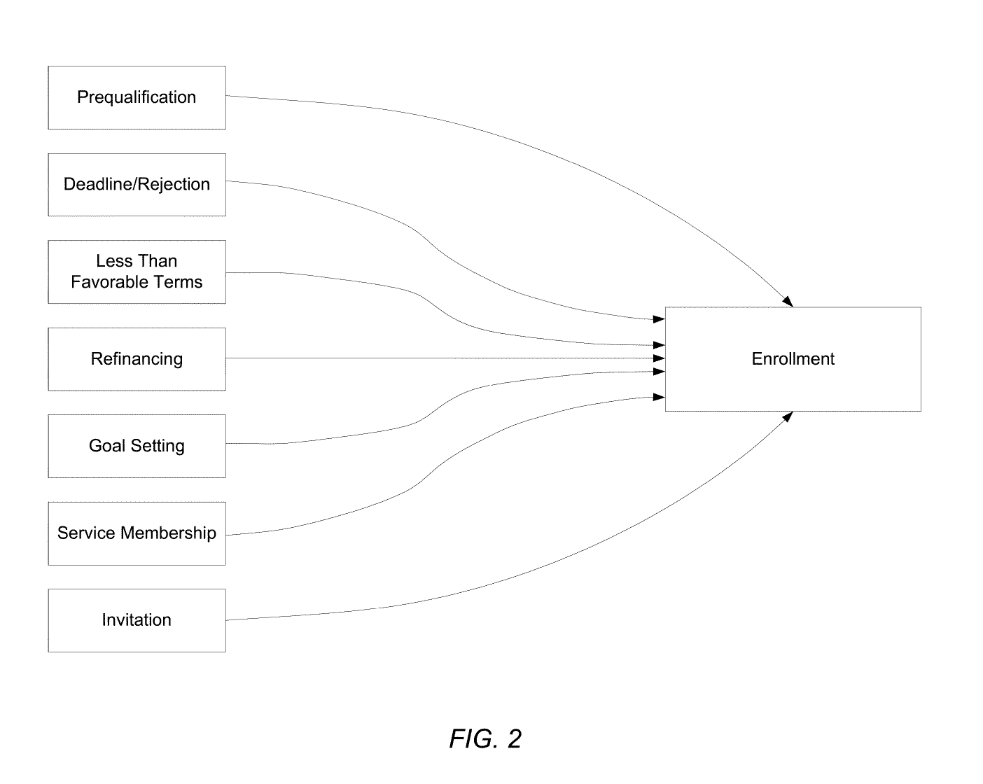

FIG. 2 displays a variety of points of entry (including manual/automated inputs and inputs integral to a particular enrollment process) based on the specific situation a consumer is in according to some embodiments of the invention. In addition to automating the capture and enrollment of a consumer, there are a variety of channels and points of entry into the service. FIG. 2 depicts different types of capture points (e.g., situations, transactions, processes, actions, decisions, services, etc.) that provide a point of entry for starting one or more processes provided by embodiments of the invention. for starting enrollment and thus the process

Pre-qualification—Capture consumers prior to offering or denial, examples would be from dealers, loan providers, CRM or any service that tracks leads/consumers prior to offering credit.

Decline/Rejection—Could be for any type of loan (e.g. auto, mortgage, personal), or any other service that uses credit to evaluate eligibility (e.g. background checks for employment, rental) or provides terms (e.g. insurance).

Less Than Favorable Terms—Same as Decline except consumer did not qualify for the best rates, payments available from provider.

Refinancing—Any consumer who has already acquired a loan may choose to lower their interest rate in the future by enrolling in the program and returning once they have achieved a threshold with a lower interest rate.

Goal Setting—Multiple financial (new or refinance home, auto, etc.) and non-financial (build credit, protect credit) based goals can be chosen or passed into system (via various methods of integration online, offline, etc.).

Service Membership—Consumers who enroll in various services both financial and non-financial can be enrolled in Credit Jeeves.

Invitation—Consumers can be invited for various paid Credit Jeeves services and plans. Example outlined later in RentTrack embodiment.

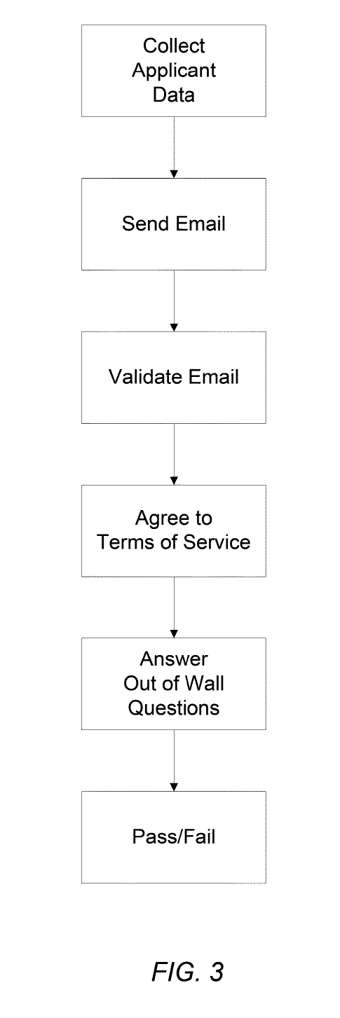

FIG. 3 is a flow diagram providing an overview of the steps involved in Enrollment according to some embodiments of the invention.
Collect Applicant Data
Send Email
Validate Email
Agree to Terms of Service
Answer Out of Wallet Questions
Pass/Fail

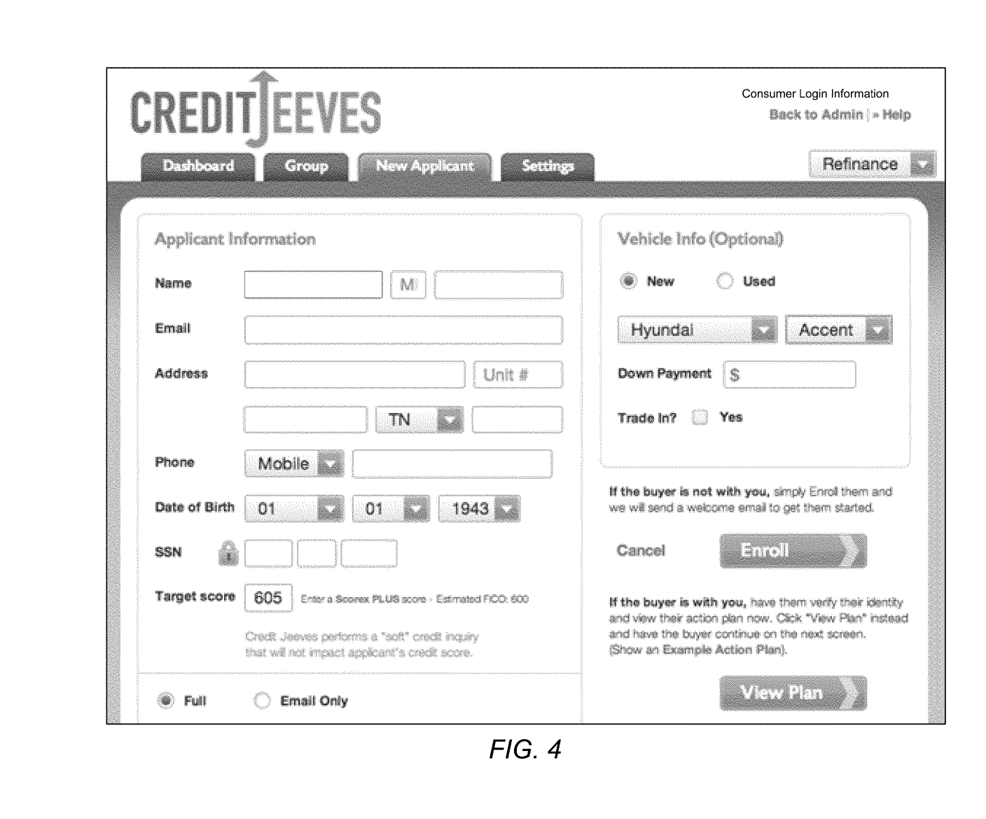

FIG. 4 depicts an enrollment interface displaying a Collect Applicant Data screen according to some embodiments of the invention.
Name
Email
Address
Phone
DOB
SSN

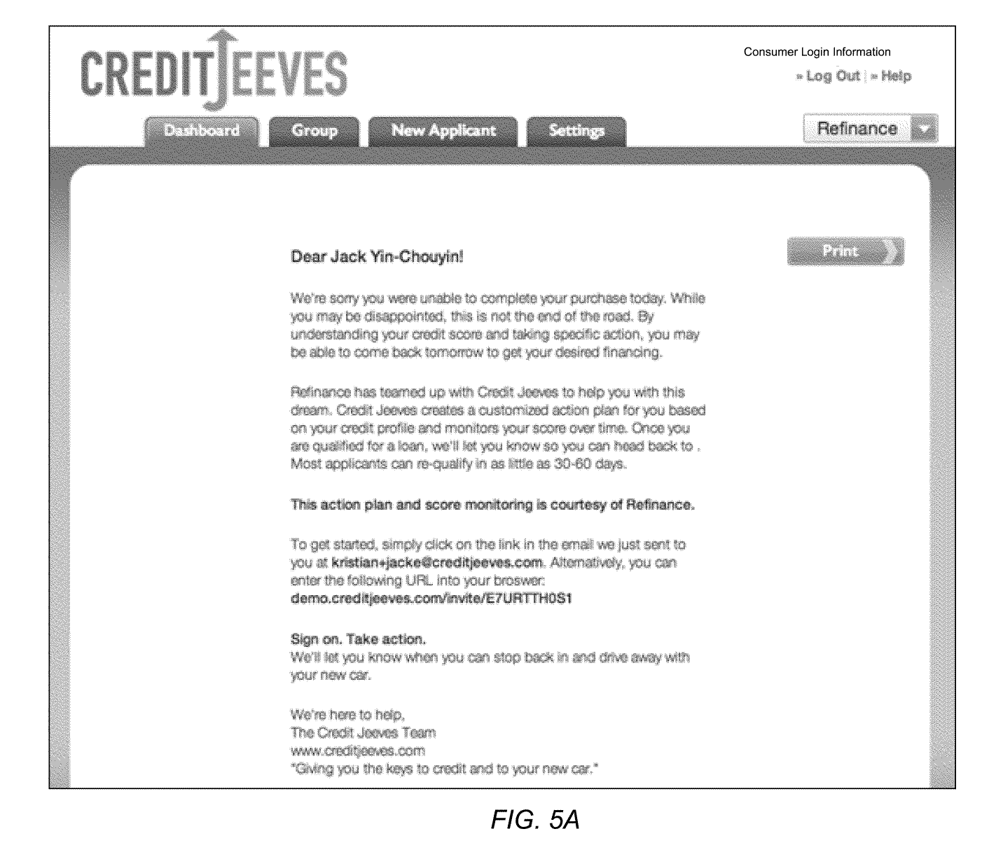

FIGS. 5A-5B display information on how to enroll after denial according to some embodiments. FIG. 5A depicts an interface showing a letter to print to hand to a consumer with instructions for enrolling in a credit processing system according to some embodiments.

FIG. 5B depicts an interface displaying an email sent to a consumer with instructions for enrolling in a credit processing system.
Applicant receives confirmation of invitation in email account provided.

Validate Email
Applicant validates DOB
Applicant creates password

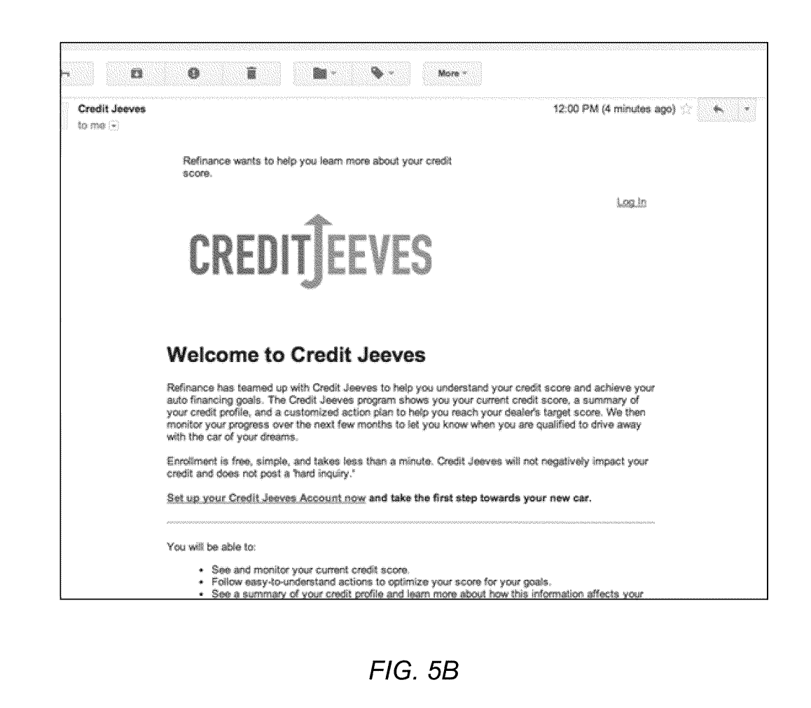

Agree to Terms of Service. FIG. 6 depicts a system interface that validates an email address to confirm the consumer's identity according to some embodiments. Confirmation can occur using consumer data such as a password, a date of birth, and/or other identifying information. The system interface also illustrates a requirement that the consumer consent to the terms of service for the credit processing system. In this example the terms include receiving a free report and acknowledging that they system may use credit scoring using a soft inquiry so as to not impact the consumer's credit.
Contains FCRA requirements
Permissible purpose

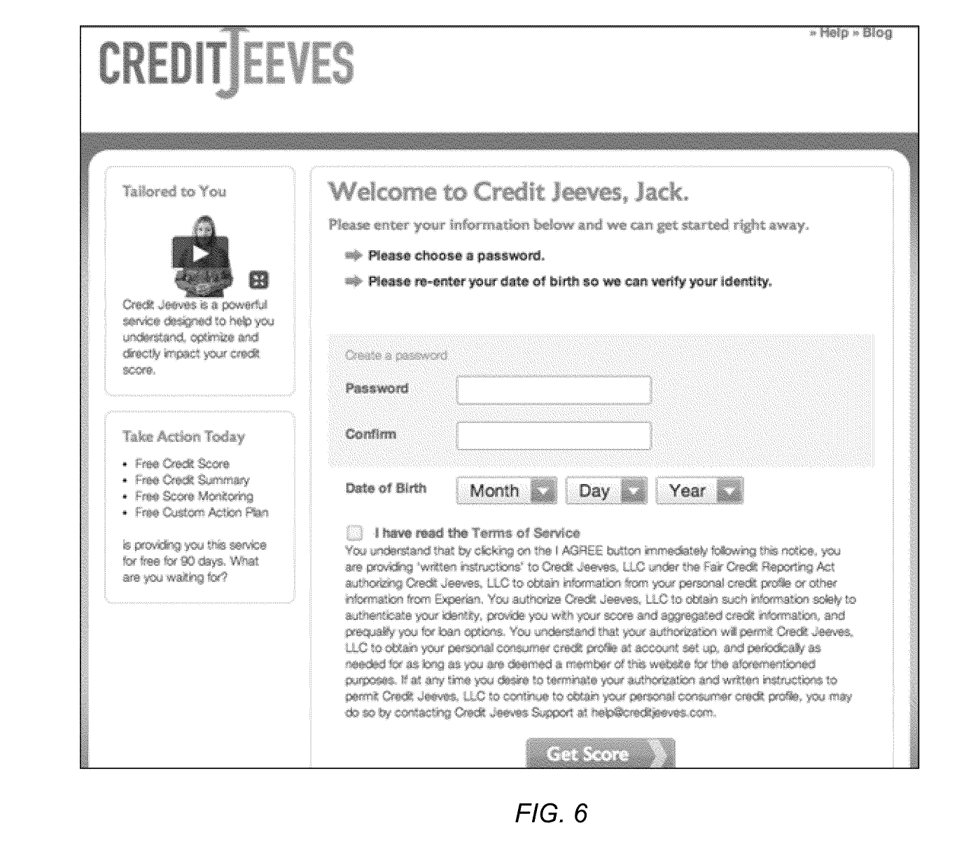

Answer Out of Wallet Questions. FIG. 7 depicts a fraud prevention system interface to validate identity based on a variety of “Out of Wallet” questions based on information not likely obtained with fraud or stolen identity according to some embodiments of the invention.
Questions generated from credit data sources
If unable to find consumer, no questions generated

Pass/Fail
Consumer required to pass 75% of questions

Coaching Procedure—

The below process is a unique approach to enabling lenders who work with consumers an opportunity to collaborate with consumers regarding specific recommendations generated for their denied applicants. This process step, called ‘Coaching’, allows the lender or sales related role to further engage consumers after denial and collaborate on what specific steps to reach a target credit score are possible and how to achieve those steps. Existing lenders in this role without Credit Jeeves do not have access to targeted personalized action plans explaining what to do, how to do it (or automating how) with predictive score changes when steps are accomplished to facilitate the denial to re-qualify process.

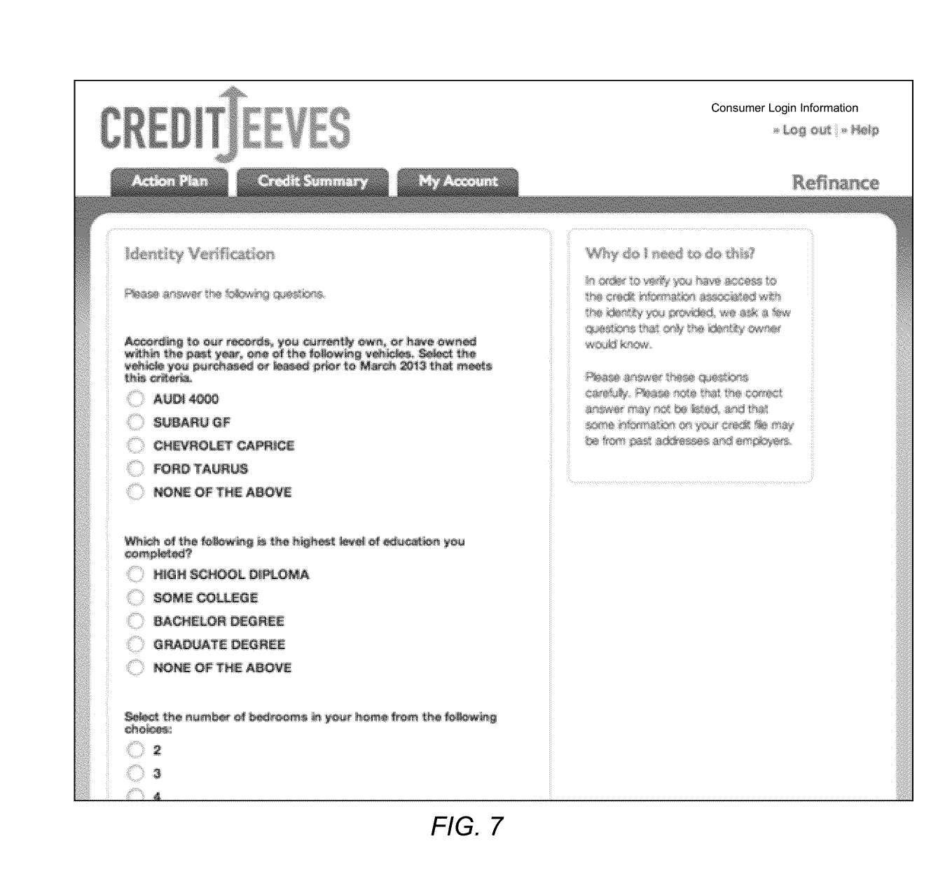

FIG. 8 is a process flow diagram illustrating a Consumer Enrollment Process with ‘Coaching’ to allow for a lender or sales staff to collaborate with consumers according to some embodiments of the invention.

In some cases there are differences between the ‘Standard’ enrollment process and the ‘Coach’ enrollment process. One different is that consumers are present at the dealership when they agree to the terms of service and walk through ‘Out of Wallet’ questions for authentication.

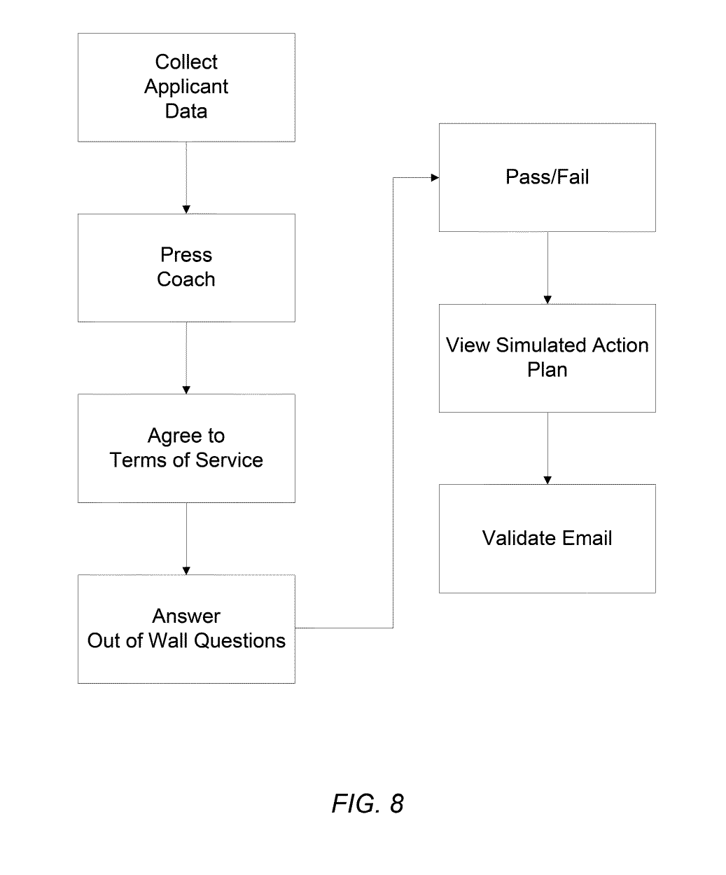

FIG. 9 depicts a system interface displaying with consumer acceptance of terms for viewing by a consumer while at dealership to view an action plan together with the dealer according to some embodiments of the invention.

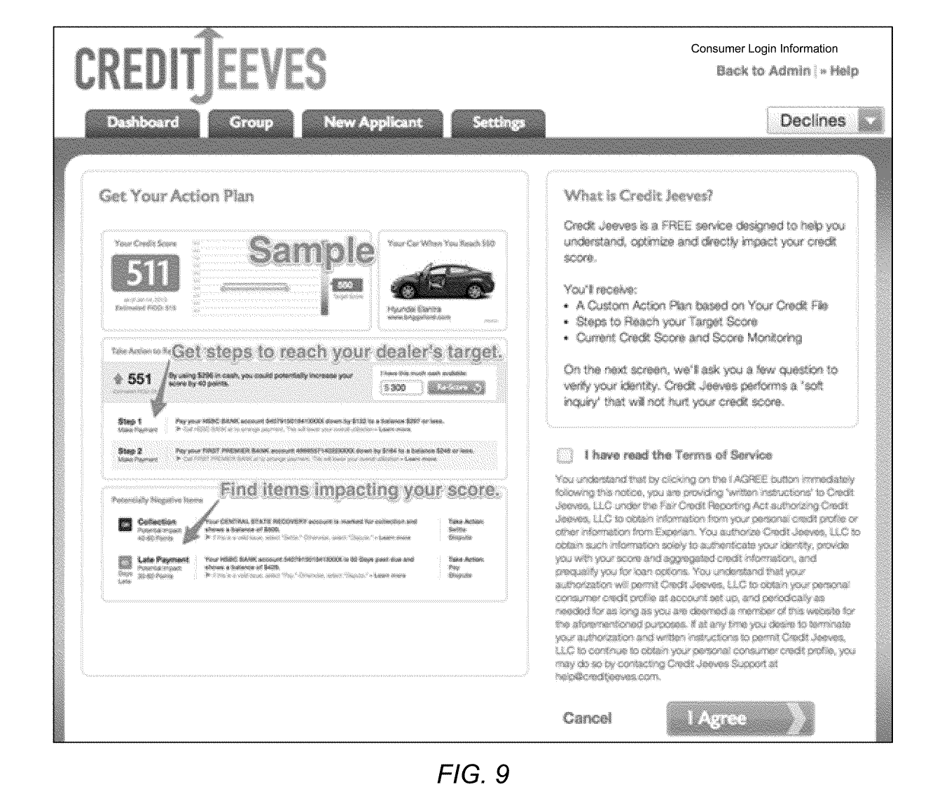

FIG. 10 depicts a system interface with exemplary “Out of Wallet” questions a consumer can answer while at a dealership according to some embodiments of the invention.

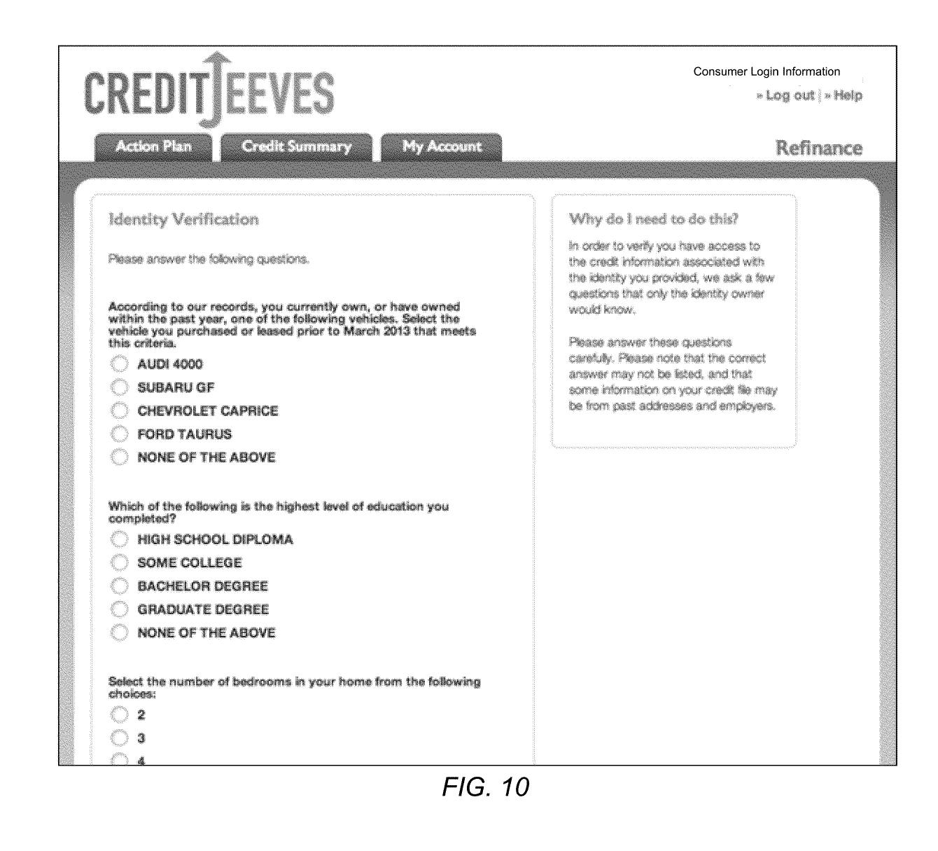

FIG. 11 depicts a system coaching interface showing an action plan (similar to a consumer action plan interface) and ability to simulate in addition to steps to achieve target credit score/tier goal according to some embodiments of the invention.

Enrollment: Goals Example—

The examples described above can be considered examples of the enrollment process within the context of a credit denial, or more generally, a negative credit event or a consumer credit event having a negative outcome.

Another example of an enrollment process within the context of setting credit and/or financial goals will now be described. This example of the enrollment process outside of a specific point of denial is the ability to enroll in the system based on the consumer choosing among a variety of credit and/or financial goals:
Purchase/Refinance a home, vehicle or any other purchase that requires a financing (e.g. appliances, furniture, power sports, etc)
Apply for new credit
Lower or consolidate credit cards and/or payments
Build Credit
Protect Credit
   This list of example goals is not exhaustive, but provided as examples of a wide range of potential goals.

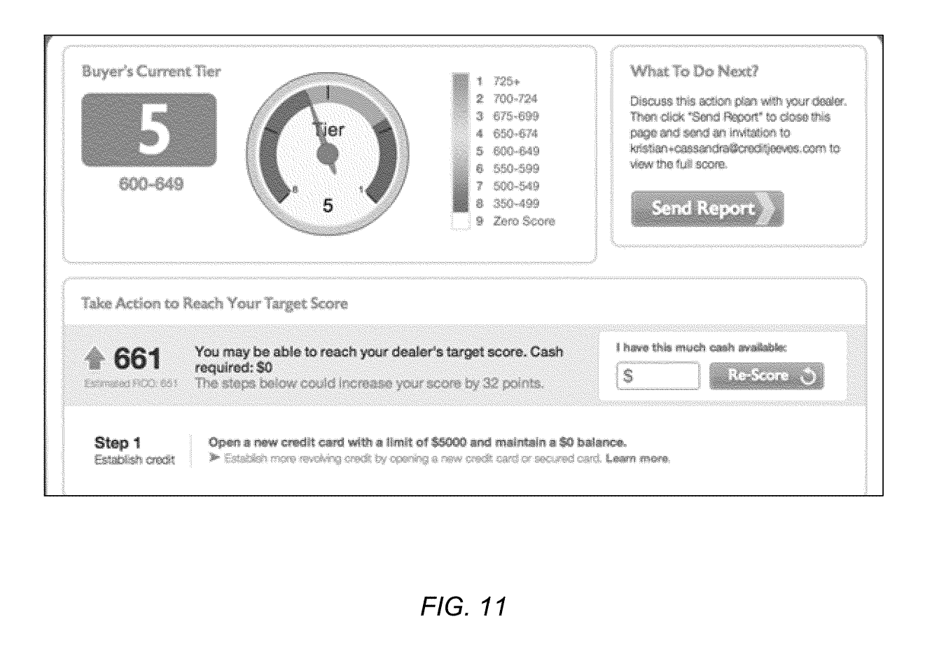

FIG. 12 depicts a system interface showing possible goals or targets for a consumer to choose from according to some embodiments of the invention.

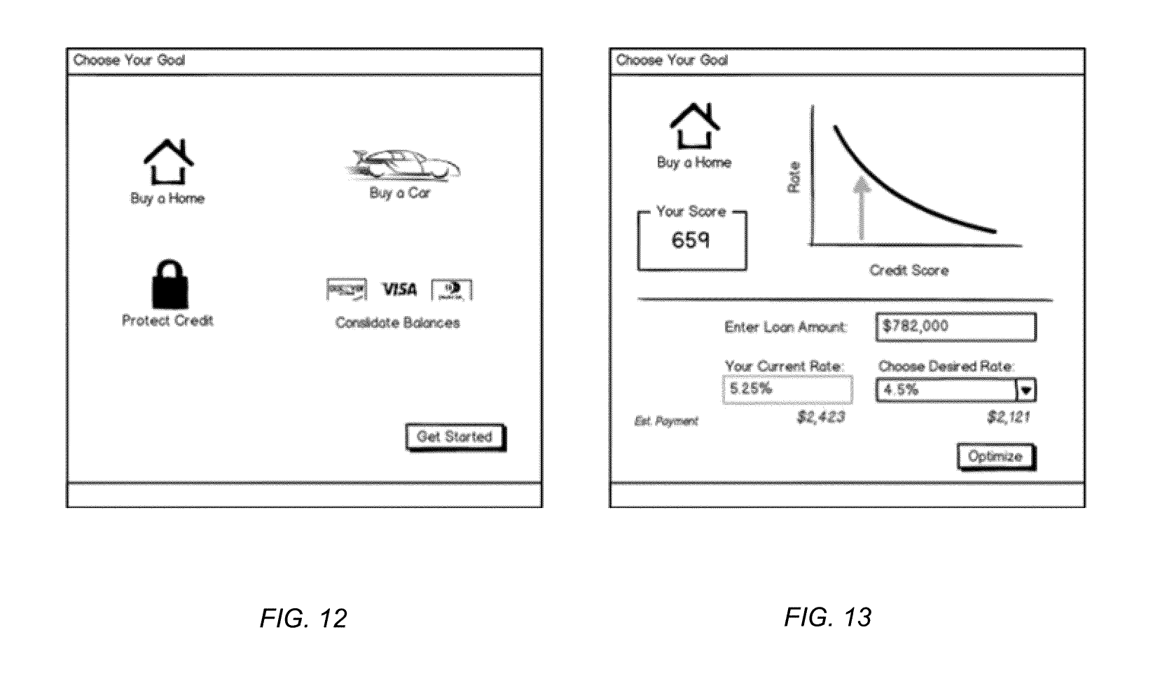

FIG. 13 depicts a system interface showing data to provide a tabular, graphical or other view of interest rates by credit score range according to some embodiments of the invention. In this case the credit processing system a view of national and local interest rates by credit score range as it is available to pull from existing data sources. As such, consumers are able to change a variety of input variables; interest rate, credit score, total monthly payment, changed monthly payment (e.g. reduce current payment $XXX or Y % per month, year) as a way to set a goal.

Enrollment: Prequalification Example—

Prequalify Process functionality process flow can be further explained as follows.

In one embodiment the software system includes an embedded application (e.g. into dealers website, software) or a standalone application. One embodiment provides pre-qualification prior to the consumer applying for credit with a business, such as an auto dealership, and integration into the software system (e.g. for declines) and into a businesses (e.g. dealerships) dashboard & pipeline.

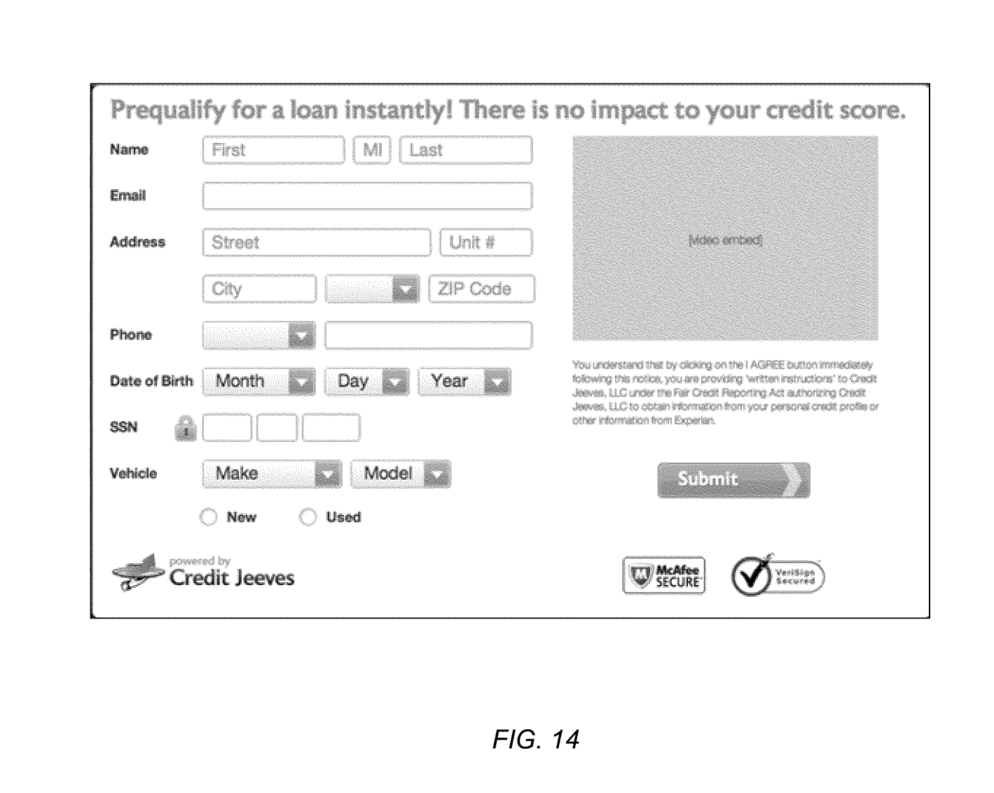

FIG. 14 depicts a system pre-qualification interface for a consumer according to some embodiments of the invention. Another embodiment includes integration with existing business (e.g. dealerships) credit applications to automatically offer the software system for declines, tier bumps. In another embodiment, the software system uses soft inquiry technology with score to help identify credit challenged & tier bumps without posting an inquiry & further impacting customers score.

Threshold Simulation and Optimization—

A rules engine and a simulation engine contain multiple sub-routines used to parse individual and aggregated tradelines based on each individual credit profile. The term “tradeline” is used herein to refer to one of a consumer's credit accounts. The parsing includes analyzing attributes of the tradeline and meta-data associated with the tradeline. According to some embodiments, the rules engine operates (e.g., follows, applies, governs) according to one or more guiding principles. In one embodiment, the rules engine operates according to at least the following five guiding principles:
1. Generate an action plan that focuses a consumer's time and resources on the fewest and most impactful events and/or actions in order to increase the consumer's credit score in the short or minimum amount of time.
2. Certain non-public records can have the greatest negative impact on a consumer's credit rating. Examples include, but are not limited to, foreclosures, bankruptcies, liens, judgments, collections, charge-offs and late payments.
3. Accounts that are paid, closed or settled with no balance, or transferred, are no longer in a consumer's control unless a statute of limitations has expired.
4. Accounts that most recently became delinquent have the highest potential to impact a consumer's credit rating, but also have the highest potential to be addressed by the consumer.
5. Provide as many means as possible to allow the resulting action plan to reduce or prevent consumer actions that negatively impact the consumer's credit score. This may involve building customized alerts and notifications based on trends specific to a consumer. For example, they system may alert a consumer that has repeatedly engaged in actions potentially harmful to the consumer's credit rating (e.g., missing payments, allowing utilization at high thresholds).

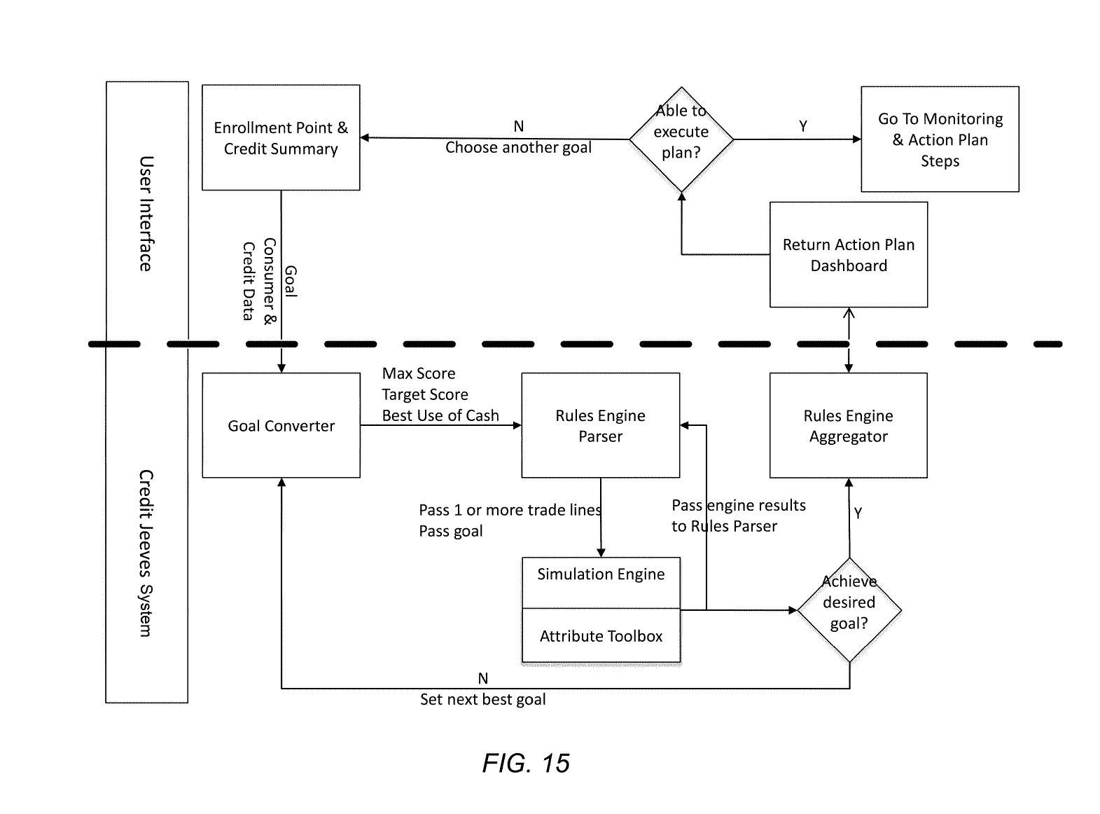

FIG. 15 is a process flow diagram illustrating the process and data flow between a user interface and other system components according to some embodiments of the invention. As can be seen, the process/data flow path includes components of the credit processing system (in this and other examples referred to as the “Credit Jeeves System”), including a rules engine parser and a simulation engine that evaluate a consumer's credit data with respect to one or more credit goals of the consumer. The system ultimately returns an action plan that can be implemented by the consumer, optionally with the assistance of the credit processing system in some cases.

According to some embodiments, the credit processing system carries out the Threshold Simulation and Optimization stage according to at least the following steps:

1. Data Input—The system receives consumer data, consumer credit goals, and credit tradeline data corresponding to the consumer. At least a portion of the data received by the system can come from a suitable Enrollment and/or Capture Point, e.g., through the use of an enrollment interface.

2. Goal Converter—The system can include a goal converter that takes all possible credit goals (e.g., either manually chosen by the consumer or passed from other systems) and converts them to, e.g., one of three, possible credit scenarios that can achieve the desired goal. Additionally, each scenario can also be manually chosen during goal setting or overridden at a later point.

3. Rules Engine Parser—The Rules Engine Parser is made up of one or more sets of rules based on the credit report tradeline and history that govern the inputs and outputs of the Simulation Engine. This includes rules by all tradeline data, metadata such as by account status, type, balance, payments, location, creditors, and many others. Examples of possible rules are described further herein.

4. Simulation Engine—The Simulation Engine generates possible scenarios based on different combinations of the tradelines, goals, and/or other criteria it may consider.

5. Communicate Recommendations to Rules Engine Aggregator—The Rules Engine Aggregator associates actual actions (e.g., carried out by the consumer or the system) with each recommended step for the determined by the Simulation Engine. This allows users to manually take each of the steps in some cases. In some embodiments associated actions may be automated, certain steps may be connected with various institutions, and/or third parties matching tradeline data may be associated with a particular step.

6. Return Action Plan—After the system determines desired steps and actions to form an action plan, the system returns the action plan to the consumer for viewing via a dashboard interface.

7. Execute steps, modify goals, set new goals.—Upon receiving the action plan, the consumer can decide best how to execute the steps in the action plan to achieve the desired credit goal. In some cases a consumer may manually carry out the recommended actions in the action plan. In some embodiments, the credit processing system can carry out some or possibly even all of the action plan's recommended steps. For example, the system may present the consumer with an option to visit the website of an affiliated third-party that provides a service to the consumer. In some cases the system may carry out the action itself on behalf of the consumer. For example, the system may make automatic withdrawals from a bank account to pay down a credit tradeline upon the consumer's instruction.

Rules Engine Parser Details—

One function of the Rules Engine Parser is to evaluate the iterative simulations generated by the Simulation Engine based on the credit tradeline data and credit goals that are passed into the system. The Rules Engine Parser can in some cases load the criteria or rules of one of a variety of different Rules Engines and then proceed to parse the desired data according to the particular rules currently in effect. Some examples of Rules Engines include, but are not limited to a Utilization Rules Engine, a Delinquency Rules Engine, and a Credit Limit Engine.

According to some embodiments, the Rules Engine Parser, the Simulation Engine, and/or other components of the credit processing system may utilize one or more search algorithms to determine whether a simulation generated by the Simulation Engine achieves the desired credit goal. In some embodiments, a binary search algorithm can be used. In one example, a binary search method can be used to build a credit utilization model or trend line or curve. TABLE 1 provides one example of a binary search scenario in which a utilization curve is generated according to the depicted relationship in order to determine an optimal “ScoreImpact” based on tradeline usage and balance amounts.

TABLE 1

Trendline for Utilization Impact
ScoreImpact = αCashp³ − βCashp² + γ3Cashp + δ
Damper Coefficients
α = Utilization % of each account relative to total accounts
β = Weighted average of utilization by account type
γ = Negative Influence of tradelines to total revolving balance
δ = Ratio of new credit total credit age by account type

TABLE 2 shows steps used by the Rules Utilization Engine to calculate an optimal score impact based on individual and aggregate tradeline utilization and balance impacts. In some cases this includes the impact of paying down balances, and increasing limits across all account types. In this case it does not include the removal of accounts, consolidation of accounts or the opening of new accounts.

TABLE 2
Utilization Engine Steps

Run Limit Increase Binary Search to Build Utilization Curve
Find Damper Coefficients - alpha, beta, gamma
Find max derivative for slope, set CashL
Run Cash Binary Search to Build Utilization Curve
Find Damper Coefficients - alpha, beta, gamma
Find max derivative for slope, set CashB
Return

Example of Utilization Engine Operation—

TABLE 3 includes tabular results of simulations via such a Binary Search method to build a Utilization Curve.

TABLE 3
Utilization Curve Table

| | | | | Utilization | | | |
|---|---|---|---|---|---|---|---|
| | | | | w/Increase | | | Simu- |
| | | | | Credit Limit | Cash | | lation |
| | Credit | Simu- | Utili- | by Simu- | Pro- | | Score |
| Debt | Limit | lation | zation | lation Cash | posed | Score | Impact |
| 3746 | 4250 | 0 | 88% | | 0 | 579 | 0 |
| 3246 | | 500 | 76% | 79% | 500 | 587 | 8 |
| 2802 | | 1000 | 66% | 71% | 944 | 594 | 15 |
| 1783 | | 2000 | 42% | 60% | 1963 | 668 | 89 |
| 746 | | 3000 | 18% | 52% | 3000 | 689 | 110 |
| 0 | | 3746 | 0% | 47% | 3746 | 704 | 125 |

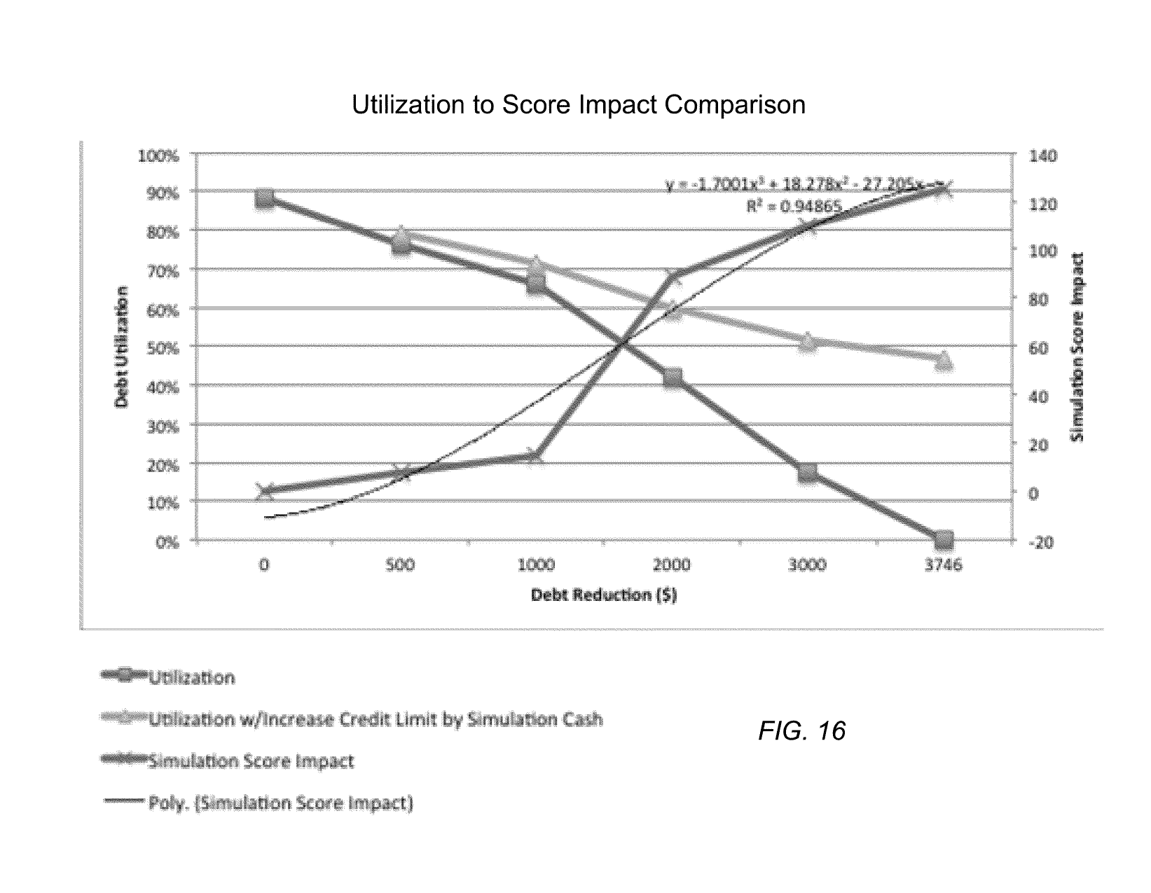

FIG. 16 depicts graphical simulation results using a binary search method to build a Utilization Curve according to some embodiments of the invention.

TABLE 4 includes information contained in the Delinquency Rules Engine according to some embodiments of the invention.

TABLE 4
Rule Guiding Principles

| | |
|---|---|
| | Focus system and consumer time and resources on the |
| | fewest, most impactful events (actions) to increase |
| | credit scores in shortest amount of time. |
| | Outside of public records - foreclosures, bankruptcies, |
| | liens, and judgments; Collections, Charge-offs and |
| | late payments hurt current accounts and have the |
| | highest potential to impact credit |
| | Accounts that are paid, closed/settled w/no balance, |
| | transferred, etc. are no longer in consumers control |
| | unless past statute of limitations |
| | Accounts most recently delinquent have the highest |
| | potential to be addressed by consumers |
| Account | 357.F3 Account Condition Code - Only Open, |
| Condition | Collection, Charge-Off first |
| 1a | If Account is in Collection (not historically, only |
| | currently) by OC |
| 1b | If Account is in Collection (not historically, only |
| | currently) by 3rd party |
| 2 | If account is in Chargeoff (not historically, only |
| | currently) |
| 3 | Open Accounts with Payment status Delinquent (see |
| | Payment status rules, starting with highest delinquency) |
| 4a | Open Accounts with Payment status Current but was |
| | delinquent (see Payment status rules) |
| 4b | If account is closed and has a balance, look at recency |
| | because this account will be used in simulation and will |
| | impact score. |
| Payment Status | 357.F3 Payment Status |
| Rule 3. Current | |
| Delinquent | |
| Accounts | |
| 5 | accounts with only 1 delinquency (more than 1 will be |
| | harder to negotiate, payoff and update status) |
| 6 | accounts most severely delinquent (180 most, 30 least) |
| 7 | accounts with most recent delinquent date - see segment |
| | 357.F2 |
| 8 | accounts with more than 1 delinquency |
| Rule 4. Was | |
| Delinquent | |
| Accounts | |
| 9 | accounts with only 1 delinquency (more than 1 will be |
| | harder to negotiate, payoff and update status) |
| 10 | accounts most severely delinquent (180 most, 30 least) |
| 11 | accounts with most recent delinquent date |
| 12 | accounts with more than 1 delinquency |
| Rule tie | |
| breakers | |
| 13 | accounts with lower number of delinquencies on same |
| | account (i.e., account with 2, 30 day lates should be |
| | shown before 3, 30 day lates) |
| 14 | accounts with higher delinquency amount are higher |
| | priority (i.e., account with $1000 past due should be |
| | before $500 past due) |
| NON OPEN | |
| ACCOUNTS | |
| | Any non-open accounts that are not in good standing and |
| | beyond 7 years should be shown (except for |
| | bankruptcies/judgments) |
| Rule | |
| Exceptions | |
| Accounts in | |
| disputed status | |
| Disputing/ | Rules that make certain accounts more likely to have |
| Account | inaccuracies |
| Inaccuracies | |
| Rules | |
| ECOA Code | Non individual accounts have a higher likelihood of |
| | being inaccurate due to a second party (spouse, |
| | cosigner) impacting account |

TABLE 5 comprises information that can be found in a Credit Limit Engine according to some embodiments of the invention.

TABLE 5
If totalCC accounts > α then

Be open and in good status (no negative items)
Have been open for more than β relative to average age of credit
(with history of good payment)
Have a lower credit limit relative to other credit cards (room to
increase)
Cards that have inquires > K months. If less, do not recommend.
Is not a secured credit card type
Total inquiries in last K months (that have different permissible
purpose) < λ

According to some embodiments, the Simulation Engine may carry out one or more of the following examples.

Top Level 1—Tradelines: Pass all; Goal: Max Possible Score.

In this scenario the Simulation Engine parses all tradelines by considering the effect of changes to some and/or all tradeline attributes (e.g., status changes, payments, utilization, etc.). The Simulation Engine also parses all tradelines to consider possible changes to the set of tradelines itself (e.g., additional account(s) to open, removal of all account(s) for all account types, in all statuses such as in good standing and delinquent, consolidation of one or more accounts, etc.). The Simulation Engine can then generate combinatorial scenarios including changes to both tradeline attributes and changes to actual tradelines. Examples include consolidation of a number of accounts and paying down one or more accounts and consolidation of a number of accounts via extended equity (if for example a consumer had a mortgage with equity in home that could potentially be used).

Top Level 2—Tradelines: Pass all; Goal: Target Score.

This scenario is similar to Scenario Top Level 1, except the Simulation Engine iteratively analyzes all tradelines until the Engine reaches desired target score. According to some embodiments, the Simulation Engine maintains and follows the guiding principles discussed above in order to optimize the resulting series of changes and pick between multiple changes having similar or the same effects.

Top Level 3—Tradelines: Pass all; Specific Cash Amount.

In this Scenario, the Simulation Engine parses all tradelines to determine possible outcomes from using a specific cash amount available for actions.

Mid-Level Scenarios—Tradelines: Pass all by Account Type.

Mid-level scenarios provide a similar analysis to corresponding Top level scenarios, with one difference being that the analysis is executed by account type instead of for all accounts.

Low Level Scenarios—Tradelines: Pass all Individual Lines.

Low level scenarios provide a similar analysis to corresponding Top level and Mid-level scenarios, with one difference being that the analysis is executed by on single tradelines instead multiple accounts across tradelines or all accounts for a given type of tradeline.

According to some embodiments, a credit processing system may operate the Simulation Engine to carry out one or more of these or other Example Scenario Simulations: target score, best use of cash, and/or challenge simulator.

Target Score Goal Simulator—this simulator applies to active accounts in both good standing and delinquent, and also to inactive accounts with balances. The Target Score Goal Simulator can carry out a simulation according to these steps in some embodiments:
i. (One Step) You cannot reach that score. If so, use Max Score Goal Simulator
ii. (One Step) To reach that score, you must consolidate your credit cards onto one and pay balance down
iii. (One Step) Open up a new revolving line of credit with X limit and do not use
iv. (Multiple Step) Open up a new revolving line of credit with X limit and pay down account 1 to Y, account 2 to Z, etc
v. (Multiple Steps) pay down X account (all types) to $alpha, pay down Y account to $beta, . . .
vi. (Multiple Steps) Prioritization of pay down steps are based on weighted factors and attributes in Utilization Engine such as but not limited too; cards with lower, higher limits, longest/shortest history, lowest/highest balances, etc.
vii. (Multiple Steps) Nonpayment impacts to Balance to Limit Ratios (i.e. utilization)
viii. Request, raise credit limit on cards in good standing (i.e. See Credit Limit Engine).
ix. Notify consumer to validate reported limit versus actual limit of all revolving accounts to ensure accuracy and provide ability to contact lender to report correct limit or automate this process
x. Calculate and prioritize the likelihood certain lenders will increase credit limits based on length of account, last request made, reliability of consumer, and other factors, attributes lenders use to assess and approve limit increases.

Best use of Cash Simulator—Utilization Engine provides optimal impacts of individual and aggregate accounts, but requires Rules Aggregator to prioritize and/or filter out recommended steps.

(One or more steps) pay down X tradeline to $alpha, . . .

Challenge Simulator

Based on the Delinquency Rules Engine as well as potentially identified, common discrepancies based on a higher likelihood of potential errors. For example, joint accounts have a higher potential for reporting errors from creditors. These accounts can be highlighted for more diligent review to ensure accuracy of all account attributes (type, amount, history, etc.).

When consumers simulate the impact of Challenging following tradelines they will have the option to view potential score increase by X-points or X-Y range. These accounts may be returned or simulated independently of others or as aggregates as described above “Threshold Simulation & Optimization” above via all accounts, accounts by type, etc.

There are multiple industry standard and accepted ‘Reason Codes’ to successfully challenge tradelines that have not, for example, passed a statute limitations;
Payment never late
No knowledge of account
Account paid in full
Account Closed
Unauthorized charges
Belongs to ex-spouse
Balance incorrect
Included in Bankruptcy
Belongs to primary account holder
Corporate Account
Associated with name incorrect
Balance History inaccurate
Belongs to another person with same or similar name
Identity Theft
Other reason

As discussed, some reasons are more common and are weighted more heavily in the Delinquency Rules Engine for both recommendation and simulation impact.

Personalized Action Plan—

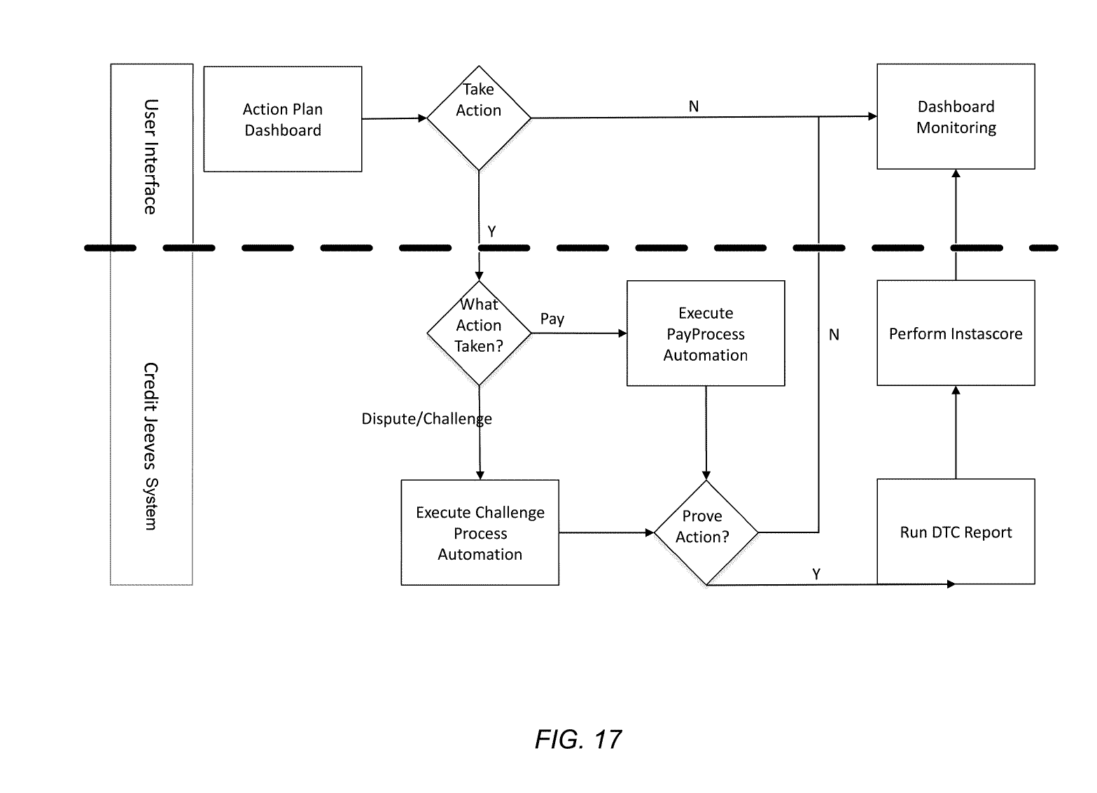

As discussed above, part of the system process is to return a personalized action plan to the consumer. FIG. 17 is a process flow diagram illustrating process and data flow between various system elements when implementing a Personalized Action Plan according to some embodiments of the invention. As shown in FIG. 17, one to many steps of a consumer's action plan can be implemented with the assistance of the system according to some embodiments. As shown, one or more steps of a pay down process can be automated within the system by, e.g., connecting bank accounts to revolving credit with, e.g., consumer approval to execute recommended steps. This includes the ability to request and store proof of receipt and/or payment from creditors, which can support other system processes (e.g., disputing, requesting InstaScore process) in automated fashion.

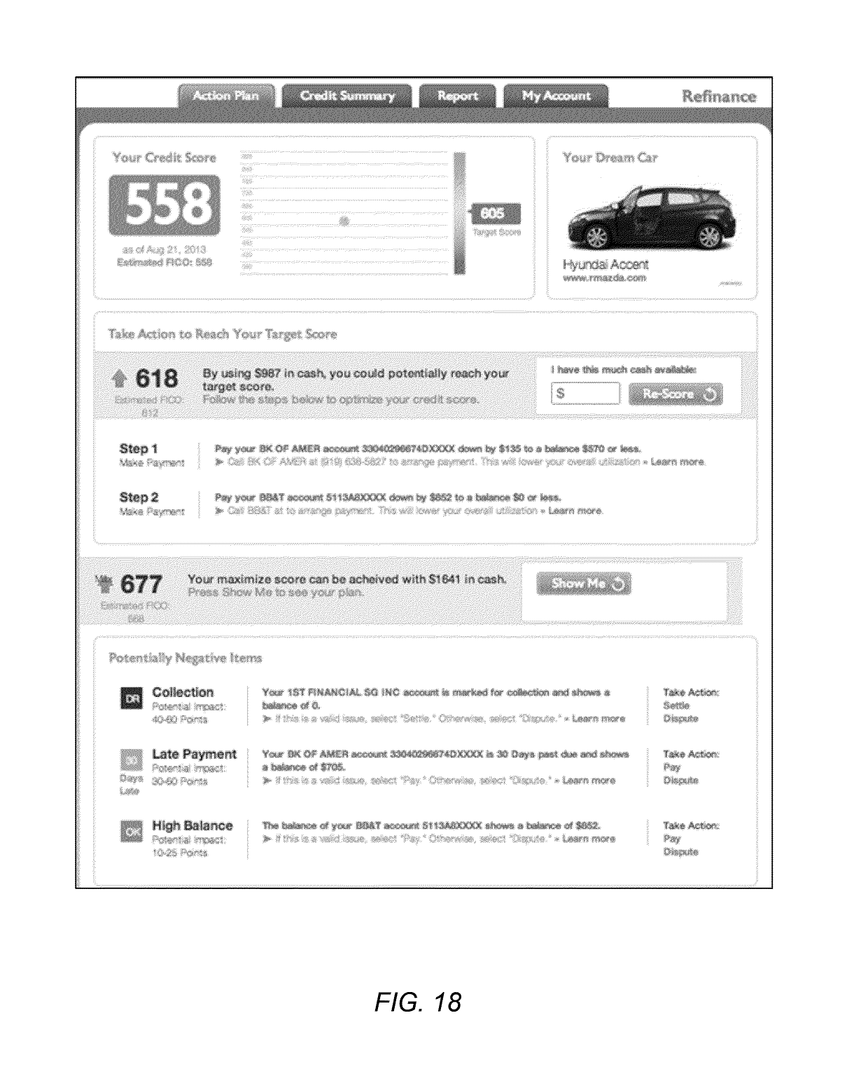

FIG. 18 illustrates an Applicant Dashboard displayed with a system interface where the applicant sees their credit score and simulation according to an embodiment of the invention. The screen illustrates a simulation section for accepting user entries such as, for example, the amount of cash to use or how much to adjust the target score by. FIG. 18 also illustrates a recommendation section that suggests actions for the user or system to take based upon the results of the simulation. In one embodiment, this information can vary depending on what steps a consumer has to take. As already described, there may be 1 step (eg. consolidated all credit cards to one . . . ), or many steps (eg. pay down balances on CC1, CC2, CC3, CC4, . . . ).

FIG. 18 illustrates an overview of applicant's credit along with actions steps for either the system to carry out or for applicant to select according to an embodiment of the invention. In one embodiment the system carries out at least one of the suggested steps based upon the applicant's selection. For example, paying down a balance with extra cash from applicant's account or another account.

FIG. 18 also illustrates a landing page for introducing the Applicant to the system according to an embodiment of the invention. The landing page may suggest steps that either the system can take or the user can take to reach the target score. In one alternative, the landing page includes a code or link to take the next step.

Executable Actions Linked to Action Plan—

The following is one example of using Connecting Steps in an Action Plan with Executable Steps. There are multiple ways to automate and facilitate the execution of recommended steps in a consumers action plan. Automation can be performed via connecting and integrating creditors, consumer financial institutions (e.g checking accounts), credit reporting agencies, as some examples. This invention includes the ability to generate a Personalized Action Plan and connecting that plan to potential executable ways to carry out the plan. One key difference between other inventions and this is the ability to connect consumers to new, not yet existing services to support this process. Meaning, enabling consumers to execute ACH or other online financial transactions is well known, but providing an alternative payment approach such as a bi-monthly payment provider does not exist.

The following are examples of calculators based on specific options to Pay Down debt. Some embodiments might provide these types of calculators as an executable option for making payments linked to an action plan:

Savings Calculator—The savings calculator will provide consumer specific savings using bi-monthly loan service based on specific criteria: loan creditor, payment date, current and proposed payment frequency, current and proposed payment amount, type of loan (installment—personal, auto, student, or mortgage), initial loan amount, current loan balance, loan term or start date, interest rate.

Custom payoff calculator—To provide the impact of an early payoff using a bi-monthly loan service, the invention will leverage the Utilization and Simulation engines by calculating utilization and passing the opening, closing accounts impact for future dates to simulate a score impact.

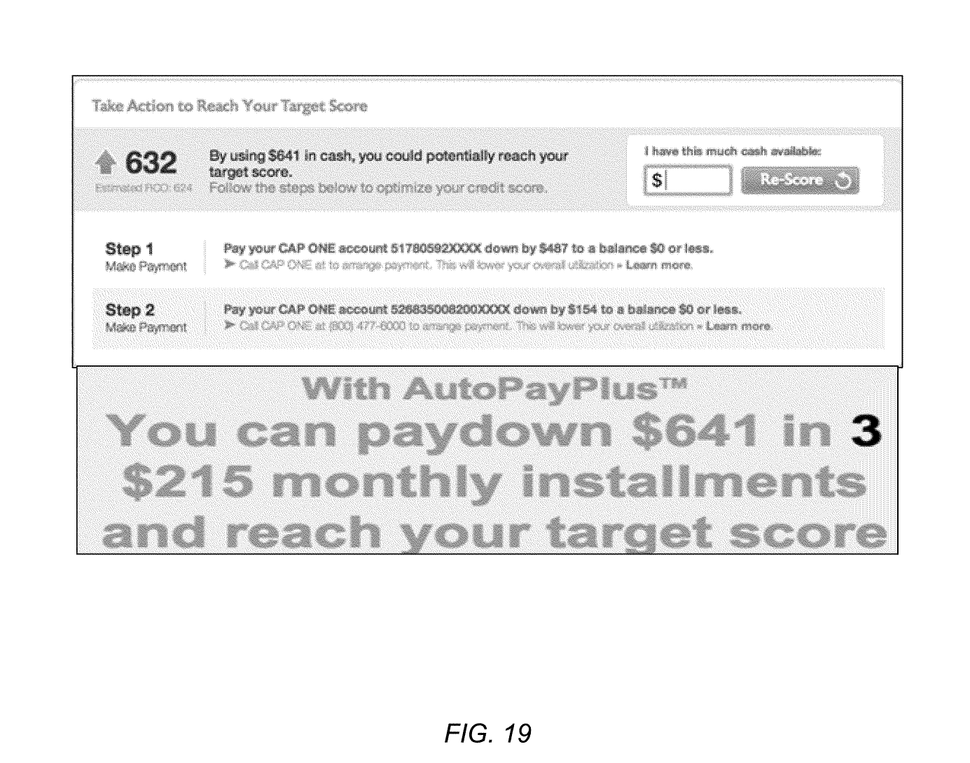

FIG. 19 depicts a system interface showing an example of an Action Plan with specific executable action plan steps according to some embodiments of the invention.

Association of Action Plans and the Impact to Credit Reports, Scores, and History—

As discussed the systems and related methods may provide ‘actionable steps’ and ‘challengeable steps’ as part of the consumer action plan. In one embodiment, there are 5 factors in order from most influential to least that the impact a credit score; for example, 1. Payment History, 2. Debt Ratio, 3. Credit History, 4. Mix/Type of Credit, 5. Inquiries. In one known embodiment the 2 most influential factors can be influenced within the InstaScore process timeframes and 1 additional (Types of Credit) within 90 days. In one particular embodiment, Credit History and Inquiries cannot be impacted.

In one embodiment, Actionable Steps may be defined as steps the consumer can take to impact Debt Ratio (referred to as credit card utilization, amounts owed, debt to balance/limit ratios) and Type of Credit (mortgage, installment, revolving). But other definitions are possible. For example, in one embodiment, this is a combination of steps requiring no cash (i.e. increasing card limits, adding a ‘New’ mix such as installment loan) as well as steps with cash (paying down balancing to below utilization thresholds like 10%) with potentially steps that only require time (i.e. last month's payment has not shown up, so utilization is double current ratio).

In another embodiment, Challengeable Steps may be defined as steps the consumer can take to impact Payment History (removing incorrect or addressing negative items, judgments, collections). Other definitions are possible.

InstaScore Process, Possible Impact on Action—

In one embodiment, InstaScore process refers to a feature offered to reduce the time between when a step in the Personalized Plan takes place and the credit score reflects that step. In another embodiment, updating credit reports and scores can take up to 45 days after steps occur. In some embodiments, the InstaScore process can reduce this time to 3 days. In one embodiment, the InstaScore process may require proving via documentation (such as an updated account statement reflecting paid off debt, creditors removing late payments or charge offs from an account, etc) that an existing tradeline on a credit report has changed from the party who originally reported that tradeline but has yet to submit the change to the credit bureaus. In one embodiment, for a fee, the credit bureaus may take this proof, officially validate the change with the creditor, and then make the change to the credit report and recalculate the credit score all within 3 days.

In one embodiment, InstaScore processing may be done with the dealer or the consumer can perform on their own. In one embodiment, assuming there is some way a dealer either via premium service or approval pays; the InstaScore process has the potential to reduce pre-qualification (i.e. conversion) time from 90 days to less than 7, possibly down to 3 in some cases.

In one embodiment, this may require charging dealers. In another embodiment, the system may use a fax or other communication device to expedite communication. In another embodiment the system provides methods and devices for providing the ability for consumer to send and/or receive info with, for example, a credit bureau. In one embodiment, due to the increased interaction and complexity of the process, the system may automate processes so as to manage either within software or manually with people to support.

Additional Examples of Actions and/or Automation—

The following is an example of the steps of an Asynchronous, Stateful Business Process Automation provided by the credit process system in some embodiments.

Step 1—Consumer chooses to dispute the action item and the Credit Jeeves system calls out to the bureau interface/API with a credit report number to initiate the process.

Step 2—Based on tradeline type and reason code, Software system either automates request to pull in updated documentation or provides upload capabilities for customers to manually upload documentation. In one exemplary automation example, if the consumer provided the software system with view only access to financial institutions (banks, Credit cards, etc) Software system would pull in a credit card statement showing balance and bank statement showing release of funds to credit card for payment.

Step 3—Software system auto populates the dispute data and required documents to publish to bureau. This can be automated online and sent through mail to both creditor(s) and the bureau(s) to ensure electronic and paper trail of all activity.

Step 4—Upon receipt of dispute resolution, software system automates InstaScore process to publish dispute results to bureau(s) for updated score.

Step 5—Software system receives bureau(s) results and provides notifications to dealers, consumers to complete the process.

In one particular embodiment, all of the above steps are asynchronous call outs and returns and thus could occur over a period of days or weeks. However, there embodiments are contemplated.

Dispute Item Example—

In one embodiment, when a consumer can prove a tradeline has been paid or is inaccurate (either right away or via the system and methods education process), that information can be immediately sent to a credit bureau. In another embodiment there then is a fee for rapid rescore to have the action be processed, validated, and ultimately updating the credit report tradeline and recalculating the credit score within 72 hours. In one embodiment, this can be for declines and tier bumps. In another embodiment, it may be possible that if this happens for tier bumps dealers can facilitate this process and make a sale with the potential to have the consumer return quickly and refinance to lower their monthly payment (or upsell a service). In one embodiment this is done so as to associate the charge to an activity (i.e. another lead because consumer bought car at 9%, but simulation shows disputed action will enable them to get 6%). In one embodiment, for declines, the system and methods may provide a process both in the dealer and for consumer where they can choose any one of actions to immediately dispute, collect and send off the documentation to the bureau, provide way for acceptance (or not) of the dispute and then ensure the rescore and visibility to dealer, consumer.

Action Item Example with Rescore—

In one exemplary embodiment, a member is 13 points away from target score. The system and methods simulate the best use of cash with an amount of $1000 and provides 3 recommendations to lower revolving utilization based on 3 revolving credit card accounts (A, B, C). In an exemplary embodiment, simulation results return paying off cards A, B will result in 15 point increase.

Before Action:

| Card | Balance | Limit | Utilization |
|---|---|---|---|
| A | 400 | 1000 | 40% |
| B | 600 | 1000 | 60% |
| C | 500 | 1000 | 50% |
| Total | 1500 | 3000 | 50% |

In an exemplary embodiment, a member chooses to take action to pay off cards and goes online to pay off cards A, B and then requests cards A and B send (email, fax, etc) them updated statement balances and letters showing proof of payment and balance as of payment processed date. In another example, the member receives documentation and signs into the system to choose Rescore action. In response, the system and related methods may provide a list of Rescore options (Reducing Revolving Balances) and may ask the member to send specific documentation (via fax). Upon receipt of documentation system and methods may create proper completed documentation, accesses Experian Rapid Rescore process and/or provides all required information. In another example, the system and methods informs member that Rescore request has been processed and will provide the result upon receipt from bureau. The system and methods may receive a response of a Rescore showing a 17 point increase based on action and may perform a soft inquiry on credit score to validate updated score. In another embodiment, the systems and methods may then provide the member the updated result of the Rescore process as well as the updated score. The member has now reached their target and has option of contacting business to complete the transaction.

After Action

| Card | Balance | Limit | Utilization |
|---|---|---|---|
| A | 0 | 1000 | 0% |
| B | 0 | 1000 | 0% |
| C | 500 | 1000 | 50% |
| Total | 500 | 3000 | 16% |

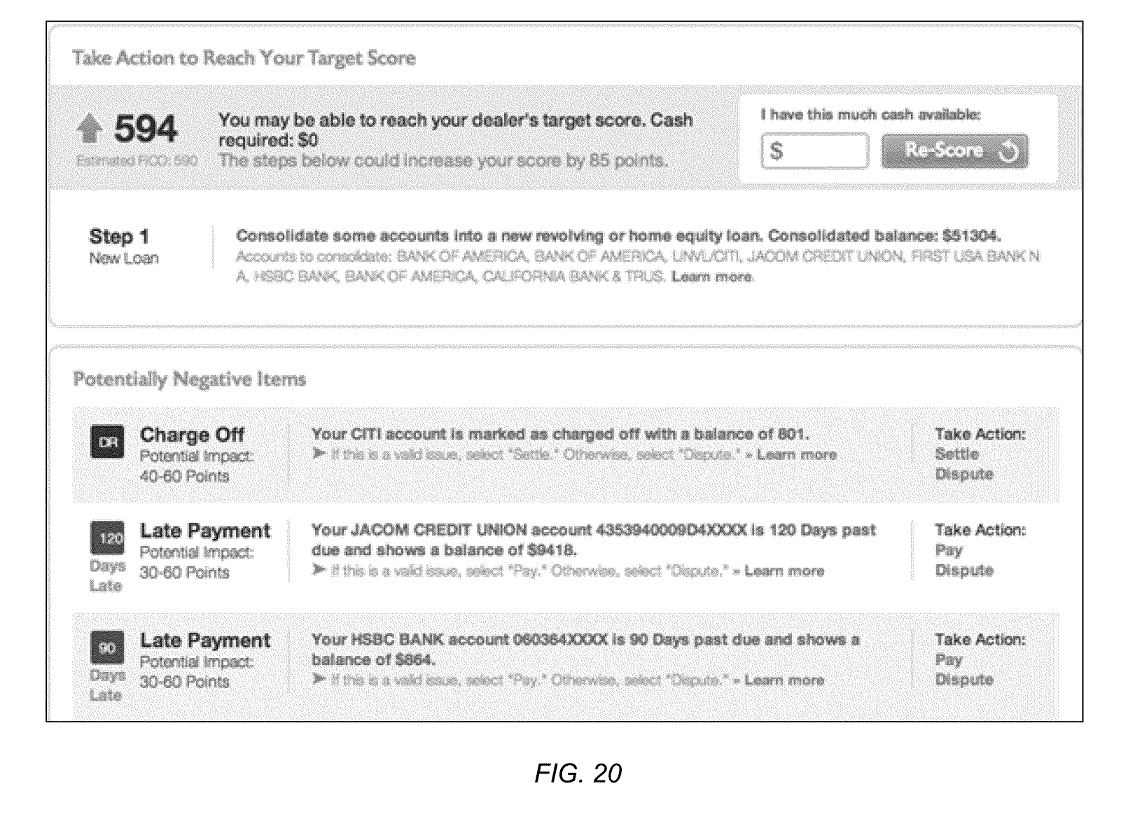

FIG. 20 depicts a system interface showing one or more actionable steps that can be taken by a user according to some embodiments of the invention. In this case the example illustrates a single Step 1 which comprises consolidating some accounts into a new loan.

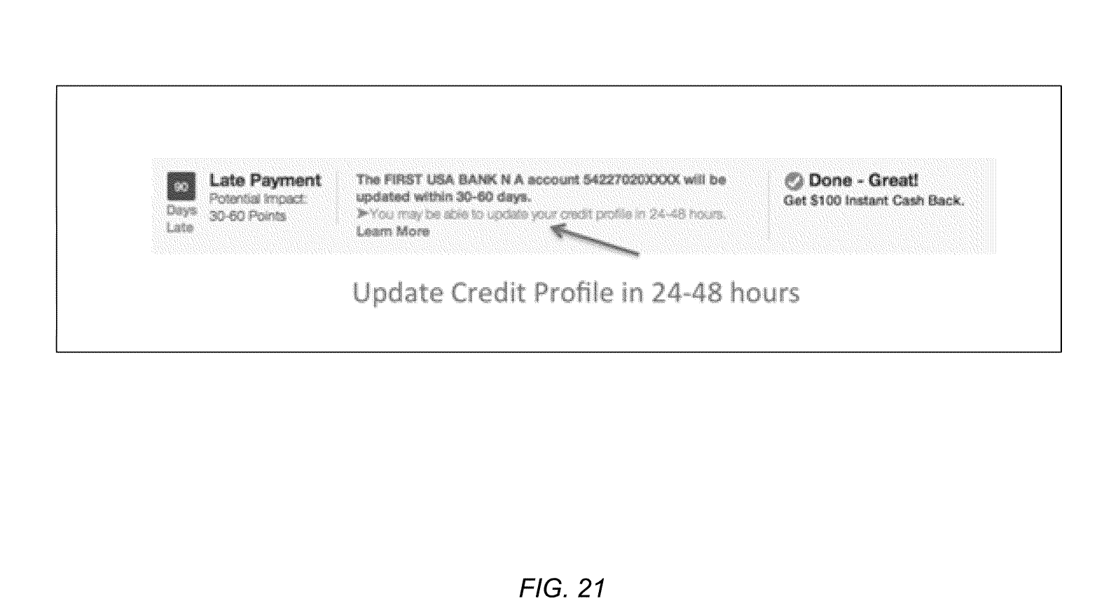

FIG. 21 depicts a system interface showing an action completed status after a user performs one of the steps according to some embodiments of the invention.

Another embodiment may provide self-verification of consumer tradeline data, both included in action plan as well as tradelines outside of action plan, which may allow consumers to view their mortgage, revolving, and installment debt tradelines and validate the accuracy of this data such as lender, rate, limit, payment amount, etc.

Additional Example of Automation—

The determination of steps to reach a target score may be fully automated. In one embodiment, the consumer enters their information at the dealer, and sees what they need to do to reach the level to receive a loan. The response may be immediate or take longer. In another embodiment, the systems and methods may reach out to multiple credit and financial data sources including credit reporting agencies, for example, Experian, get the information, use various software components to determine the steps, store the steps, and display the steps to the consumer.

Incentivization—

Consumer action plans will sometimes include incentive driven steps based on both monetary and non-monetary rewards. As consumers complete steps they may earn status, points to apply to prizes, drawings funded by various third parties including dealers, retailers, financial institutions, etc. Completing steps may also provide survey's or similar that can be filled out to win instant gift cards, credit or promotions ($off, BOGO, etc) towards retail items. Non-monetary incentives will include achieving keys to drive program steps, and accomplishments, badges rewarded—like a star or rank system.

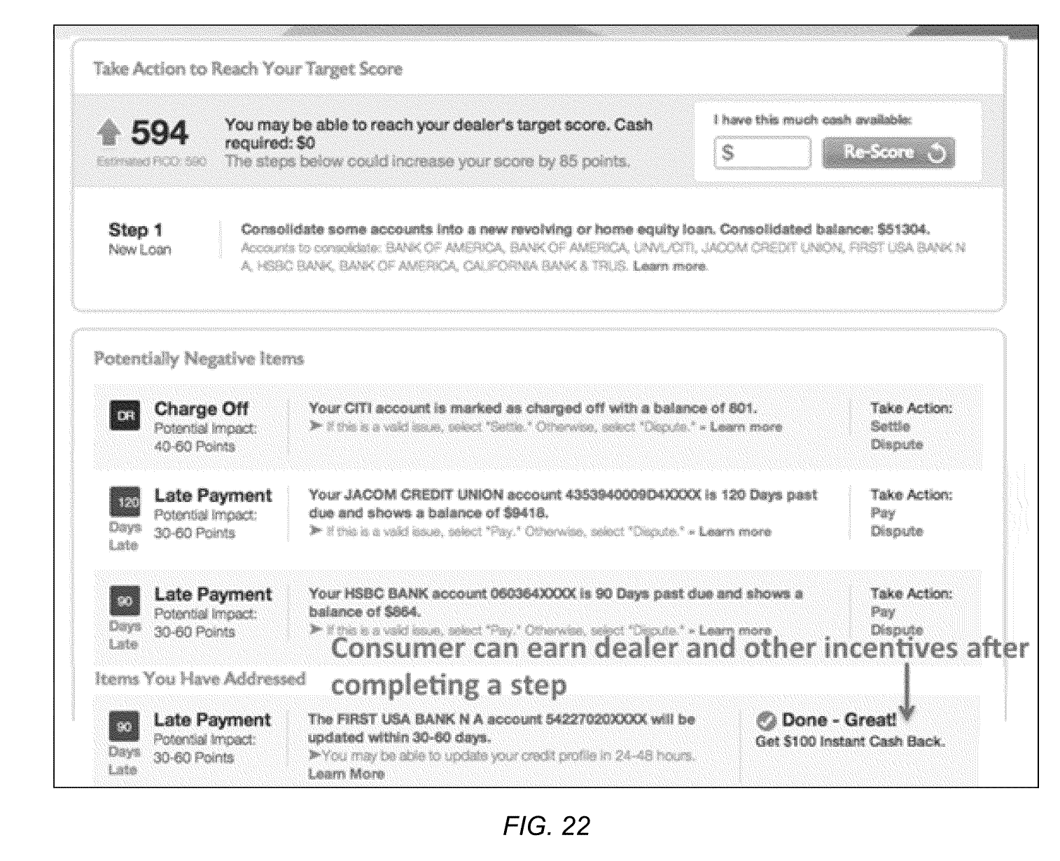

FIG. 22 depicts a system interface illustrating incentives a consumer can receive for completing a certain actionable step according to some embodiments of the invention.

Monitoring & Qualification—

The monitoring of the consumer's score may be automated. In one embodiment for example, on a periodic basis, the system and methods will contact for example, Experian, get the latest score for the consumer, store that score, update the consumer's display, and email the consumer with that information.

Alerting the dealer may be automated. For example, when the system and methods determines that a consumer has reached the target score, the system and methods may update the consumer's display, update the dealer's dashboard to show a new lead, email both the dealer and consumer with the news, and bill the dealer.

In one embodiment, each night, or on some other regular or non-regular schedule, the system automatically translates the activities within the system into a separate data warehouse for examining the conversion rates at many steps along the funnel (from rejection to activated in system to reaching target score and how long it took to buying the car). In one embodiment, these conversion rates are applied to marketing. In another embodiment, the examination of available date may be used to better understand which customers have a chance to complete the deal, and for display of the calculated probabilities to the dealer. This may be done in an automated manner or otherwise.

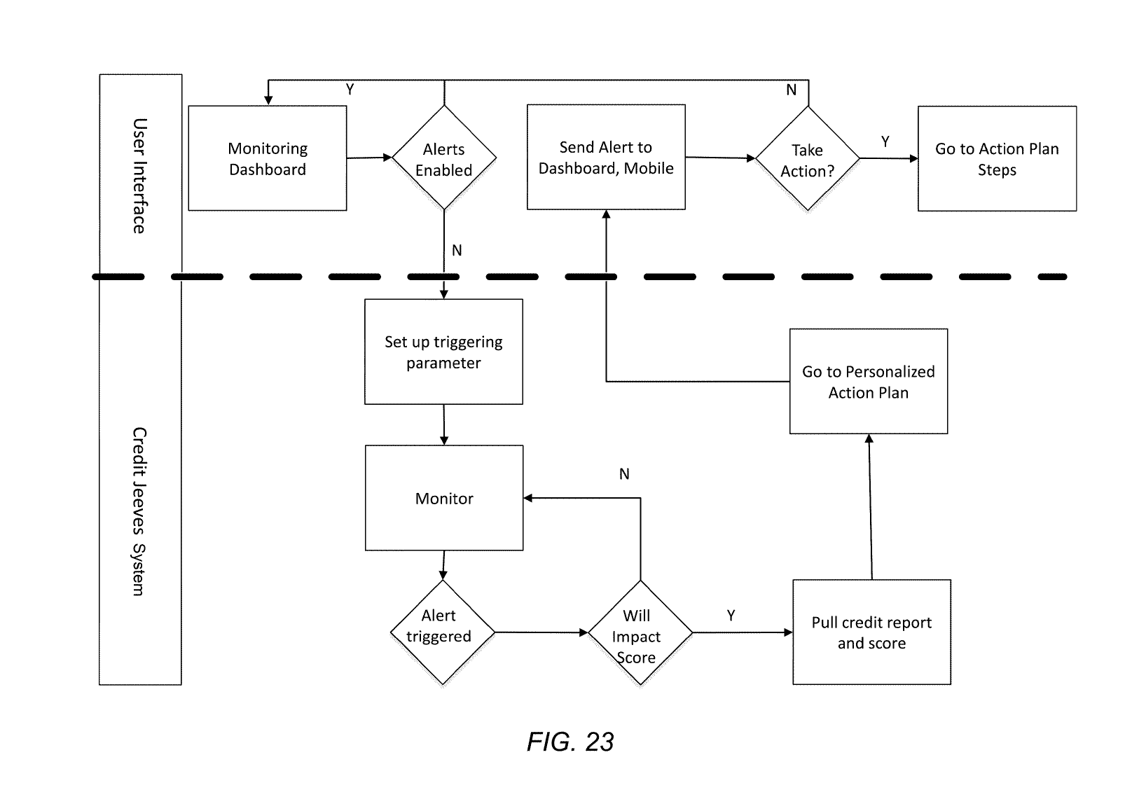

FIG. 23 shows a process flow diagram illustrating an exemplary Monitoring configuration and results of events occurring while monitoring according to some embodiments of the invention.

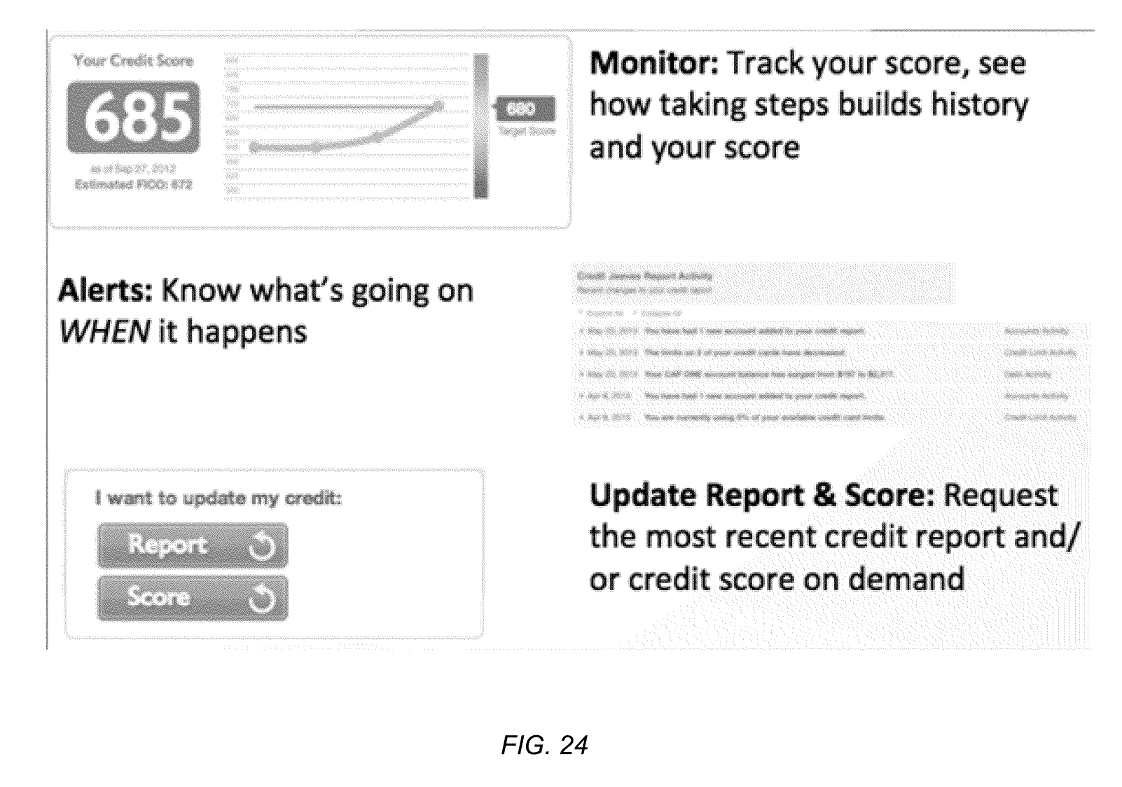

FIG. 24 depicts a system interface for showing a consumer benefits and implications of monitoring credit according to some embodiments of the invention.

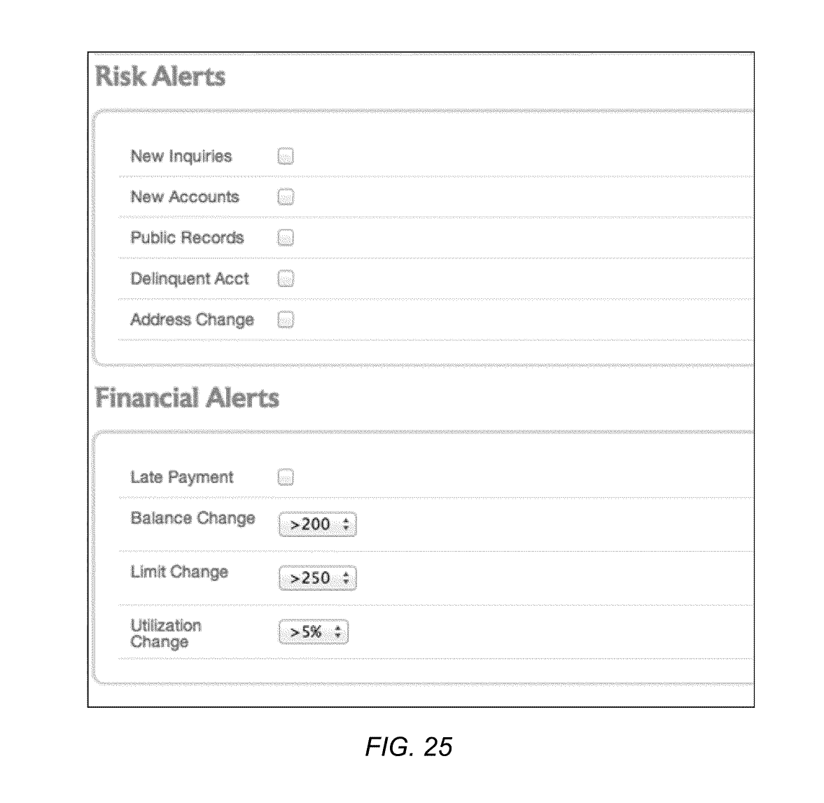

FIG. 25 depicts a system interface showing a list of parameters that can be used to set notifications and alerts for some potential risks to a credit score according to some embodiments of the invention. For example, the potential risks to credit score may not specifically be tied to financial impacts. Examples include inquiries and new tradelines, missed or late payments, 30/60/90 derogatory/delinquent status, changes in address, judgments, and collection actions. Other examples are depicted in FIG. 25.

TABLE 6 shows potential Financial risk parameters based on limit, utilization and balance changes across all account types according to some embodiments.

TABLE 6

| | Credit Limit | Utilization | Balance |
|---|---|---|---|
| Minimum | Credit limit | Utilization | Balance |
| threshold | changes of $α | percentage | change of |
| monitored | or greater | point changes | $γ or |
| | are client | of β or | greater |
| | defined | greater are | |
| | | client defined | |
| Definition | Tradeline level | Tradeline level | Tradeline level |
| | Limit increase or | Utilization increase | Balance increase |
| | decrease | or decrease | or decrease |
| | | The absolute | |
| | | change threshold | |
| | | between α and β | |
| | | percentage points | |
| Trade type | Bankcard | Bankcard | Bankcard |
| options | Retail | Retail | Retail |
| | Unsecured | Unsecured | Unsecured |
| | Line of | Line of | Line of |
| | Credit | Credit | Credit |
| | 1^{st} Mortgage | 1^{st} Mortgage | 1^{st} Mortgage |
| | 2^{nd} Mortgage | 2^{nd} Mortgage | 2^{nd} Mortgage |
| | Home Equity | Home Equity | Home Equity |
| | Line | Line | Line |
| | | Auto | Auto |
| | | Student Loan | Student Loan |

Connect and/or Reconnect to Lender/Dealer Dashboard—

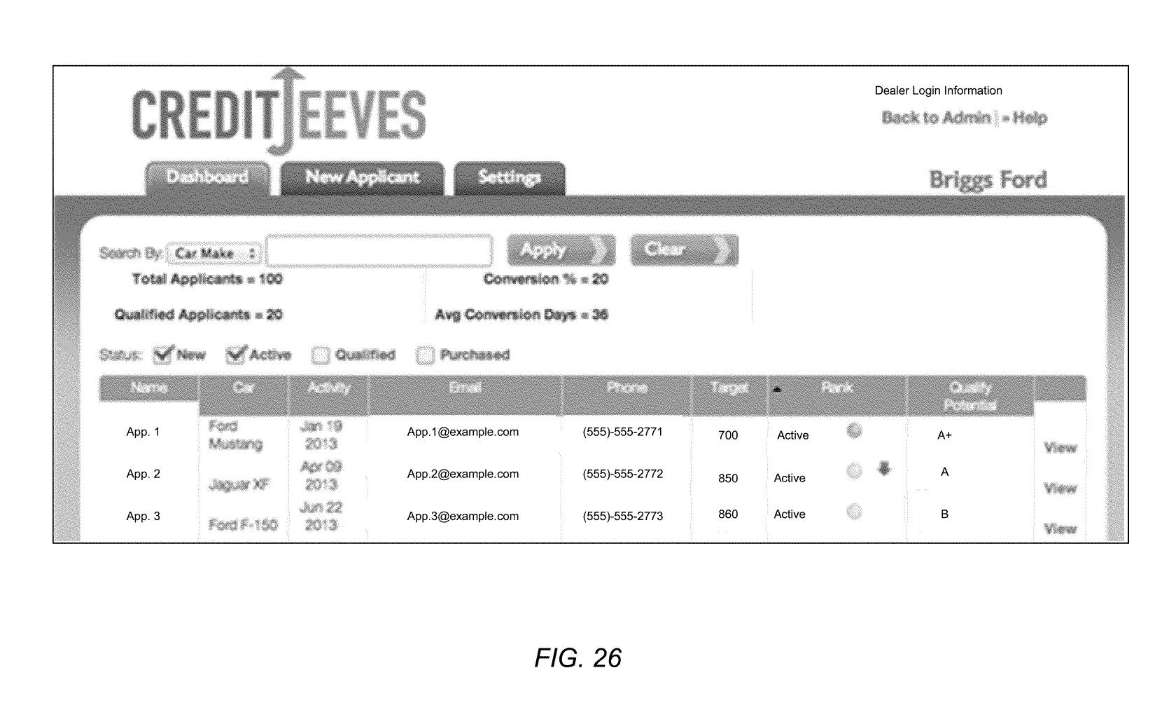

FIG. 26 depicts a system interface showing a dealer view according to some embodiments of the invention. In one such embodiment, the systems and methods will monitor the applicant's credit score. According to this embodiment, when an applicant reaches the dealer's target score, the system may notify the dealer of a prequalification in the “Recaptured” section. In another embodiment, once the dealer purchases the lead, they can see the buyer and contact information in the “Declines to Deals” section. In yet another embodiment, once the buyer actually purchases the car, they are saved for a short time in the “Purchased Car” section.

In another embodiment, the system includes a Dealer dashboard with status monitoring that provides additional consumer metrics such as consumer progress (e.g. consumer is 80% toward goal based on delta between original score and target), and consumer ‘Quality Potential’. This Dealer Dashboard can also provide a scorecard that includes conversion %, Average Conversion days, among many other metrics derived from consumer activity as shown below.
Dealer Scorecard—Summary of the total applicants for dealer, qualified applicants, % of applicants converted, average days to convert applicants, recent applicants.
Conversion % (Cp)

Cp=(Qualified Applicants Reaching Target Score)/(Total Active Applicants).
Avg Conversion Days (Ca)

Ca=Σ(App Qualified Date−App Enrollment date)/Σ(Qualifled Applicants)
Rank—The combination of a status (new, active, qualified, closed), Score Progress (Sp), and recent score change (Increased, decreased, no change).
Target Score (ScoreT), Consumer Score (ScoreC).

Sp=(ScoreT−ScoreC)/ScoreT

Another embodiment may include a Consumer ‘Quality’ or ‘Qualify Potential’ rating based on credit analysis to provide dealers a grade or likelihood consumers will reach a target. The factors, attributes that will determine the ‘Qualify Potential’ will be based on existing consumer credit score, and the elements of the consumer credit history that can be influenced within 1-90 days. These factors and attributes will include: score increase needed to achieve target, number of negative tradelines to be impacted, number of action items that can influence debt utilization. An example equation is shown below:

Qp=[(ScoreT−ScoreC)/ScoreT+Tradelines Impact/Total Tradelines+(Σ(Debt Utilization Total impact))/Σ((Debt Utilization Current Impact))]/3.

An Example Qualify Potential Scale is shown in Table 7 (with more granular definitions that are configurable by dealer such as ‘+’, ‘−’)

TABLE 7

| Percent | Grade |
|---|---|
| >95 | A+ |
| 85-95 | A |
| 75-84 | B |
| 65-74 | C |
| 50-64 | D |

These ‘Qualify Potential’ factors, attributes will evolve into more in depth analysis to such as deeper evaluation of negative lines weighted with potential to impact. One example would be consumer 2 is 25 points from reaching next threshold/target score but has no negative items, low utilization, and needs to build credit history (i.e. college student) has a “C-” Qualify Potential. Consumer 2 is 40 points from threshold, has 2 negative items (e.g. late payment to dispute), with a 60% debt utilization is an ‘A+’ Qualify Potential. In such an exemplary scenario, the software system may potentially create a tiered lead sale system of both leads not yet qualified and leads already qualified. In a further embodiment, the software system may also enable dealers to prioritize follow-ups, offers, etc. to consumers based on their potential to qualify.

Dealers may also have the option to associate the leads score increase potential to a financing tier (or “Rate Card”) and determine the potential gross increase based on lenders offering financing in the proposed tiers (“Rate Cards”). This could be part of the integrated Dealer Simulation & Consumer Review process described where dealer is able to choose multiple goals by score, tier, use of cash, etc. As in the example table below, the resulting tier may be associated (via integration, configuration, etc.) to various data sources that provide potential revenue (gross) based on various deal parameters (including credit score, equity, trade in, loan amount, etc.) lenders use when financing.

TABLE 8

| | | | Additional Gross |
|---|---|---|---|
| Score Tier | APR | Potential Gross | (from prev tier) |
| 720-850 (Tier 1) | 3.672% | $3000 | $500 |
| 690-719 (Tier 2) | 5.064% | $2500 | $500 |
| 660-689 (Tier 3) | 7.256% | $2000 | $500 |
| 620-659 (Tier 4) | 11.041% | $1500 | $500 |
| 590-619 (Tier 5) | 16.223% | $1000 | $500 |
| 500-589 (Tier 6) | 17.414% | $500 | 0 |

In another exemplary embodiment, the system may provide Batch offers to declines, and past subprime customers using rule based target modeling of dealer CRM data (e.g. 50 subprime buyers purchased cars from dealer with a 15% interest rate in last 6 months and all have car values above 20K). Past subprime offers may be filtered based on credit score, recency of auto tradeline purchase, among other factors that will identify ideal candidates to enroll in system.

Yet another embodiment may provide secondary financing external from a dealer who may be able to finance a car at lower threshold than a dealer minimum. Consumers who were not able to reach the target score after given time period (I.e. 90 days) may be offered secondary finance offers from lenders with lower minimum credit scores other than dealers base lenders.

Another embodiment may provide threshold enrollment and tier management for dealers to have multiple target scores vs. single dealer target based on loan amount. This tier management provides dealers and consumers a range of credit scores that will have different terms and rates. This tier management can be accomplished both by dealer (or any other lender associated to the lead), or can be provided to lead directly based on enrollment channel.

### Example

TABLE 9

| | | | Savings By Tier |
|---|---|---|---|
| FICO ® score | APR | Monthly payment | (compared with previous) |
| 720-850 | 3.672% | $183 | |
| 690-719 | 5.064% | $189 | $360 |
| 660-689 | 7.256% | $199 | $600 |
| 620-659 | 11.041% | $218 | $1140 |
| 590-619 | 16.223% | $244 | $1560 |
| 500-589 | 17.414% | $251 | $420 |

In one embodiment, the system and method will analyze people within the context of the dealership (and later mortgage, etc.) markets, and characterize their likelihood to follow the steps, return, and buy, based on their original credit file. The system and method can then make this information available to the dealer, and use it within the system to more heavily monitor the promising cases.

Leads—

As noted, there is not a process today that ‘closes-the-loop’ for consumers who were denied credit (or who received less than favorable terms) when attempting to make a purchase and stay connected with the dealer/lender after the denial. A key differentiating use of this process of capture, educate, simulate with a custom action plan, build in incentives (which can be offered exclusively from lenders thus encouraging more loyalty), and ultimately active monitoring to continual associate consumers and dealers and reconnect when a target score is reached.

Exemplary Associations—

In one embodiment, the consumer view and the dealer view are linked in a datastore by a “leads” table, as is defined below. Exemplary systems and methods link an applicant and a dealer to this lead. In one embodiment, the applicant must be there. In another embodiment, the dealer can be reassigned (e.g., even reassigned to a mortgage if desired). For example, when a lead first comes in, it may be associated with that dealer. In one embodiment, if the dealer does nothing with it after a certain period of time, or declines the lead, the system and methods can make the lead available to other dealers (or to credit card companies, etc.). Each dealer (or lending institution) may have their own target score, and may dictate what they want to see to have a person “prequalified.” This score can be reset if, for example, it is desirable to pass the lead to a different dealer, in which case the system and method may compare the consumer's current score with the new lead target score. Recency may also be stored in the lead—when it was created or at another time.

The lead prices may be located in the dealer table. In one embodiment a different lead price can be set for each dealer based on a contract with that dealer.

One embodiment discloses a system and related method of attaching a lead to a dealer for a certain time, attempting to convert that lead for that dealer, but if no conversion, then the ability to attach that lead to other local dealers (e.g., perhaps by highest bid price first).

Lead Auction to dealers for consumers who qualify, but may not return to original dealer—See Consumer Qualify Potential below.

Incentivizing (including gaming) for each step consumers take (monetary and non-monetary)

Partner offers (credit card w/low rate, loan refinance)

Consumer progress, status monitoring (steps accomplished, etc.) built into overall process to access steps taken, impact of those steps, and what steps to still take.

cjLead:
actAs: [Timestampable]
columns:
   cj_applicant_id: {type: integer, notnull: true}
   cj_account_id: {type: integer}
   target_score: integer
   best_of_cash: integer
   result: object
   status: {type: enum, values: [new, active, finished, expired, processed, ready, passed], default: new, notnull: true}
   source: {type: enum, values: [office, webpage], default: office, notnull: true}
relations:
   cjApplicant:
      on Delete: CASCADE
      local: cj_applicant_id
      foreign: id
      foreignAlias: cjLeads
   cjAccount:
      on Delete: CASCADE
      local: cj_account_id
      foreign: id
      foreignAlias: cjLeads

Integrated Process Flow Example—

The following section outlines a specific example of how the end-to-end process invention is applied in an integrated process flow at an auto dealership where the system and process integrates at multiple points in the sales lifecycle. Multiple integration methods and technologies are utilized such as user interface, direct data and service calls, external and internal application programming interface (API), that create a seamless experience for both the dealer and consumer.

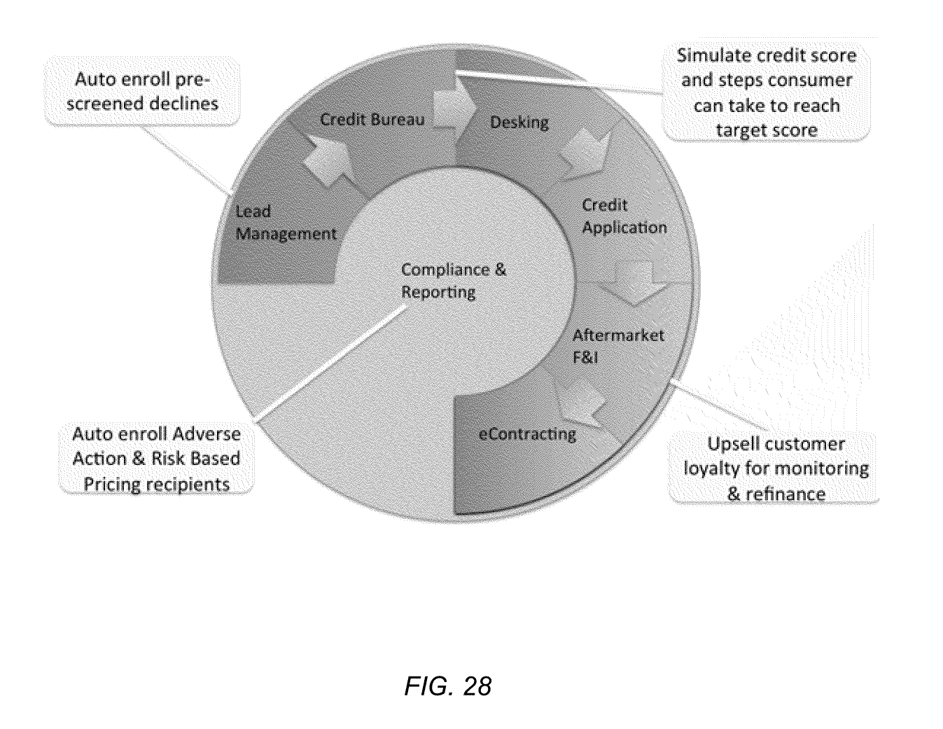

FIG. 28 illustrates a flow process for applying a credit processing system during an auto sales cycle and auto post-sales cycle according to some embodiments of the invention. Note there are multiple points of integration points and methods used to both facilitate the capture as well maintain the consumer, dealer relationship (even post sale) enabling dealers to reconnect and add value add to their process for consumers. For example, dealers can leverage the service to upsell consumers during the F&I (finance & insurance) process to provide consumers:

A way to enroll consumers prior to entering the dealership whom attempt to ‘pre-qualify’ but do not meet minimum credit score, income, equity requirements.

A way to set a future goal to refinance their loan at a lower interest rate if they improve

A way to set a future goal to trade-in/purchase a new vehicle at a lower interest rate if they improve

A way to offer credit education and monitoring, with future incentive offers (e.g. discounted or free auto maintenance service plans)

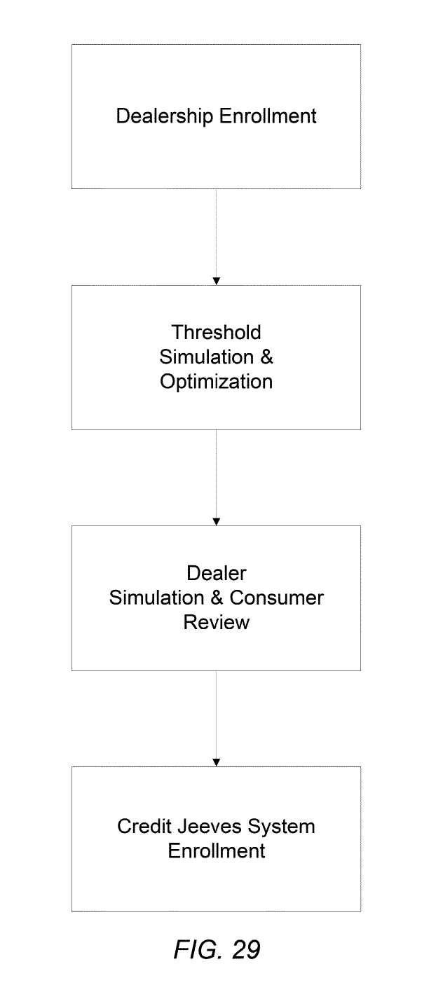

FIG. 29 is an illustration of an exemplary process flow of multiple steps integrated into auto dealer sales cycle.

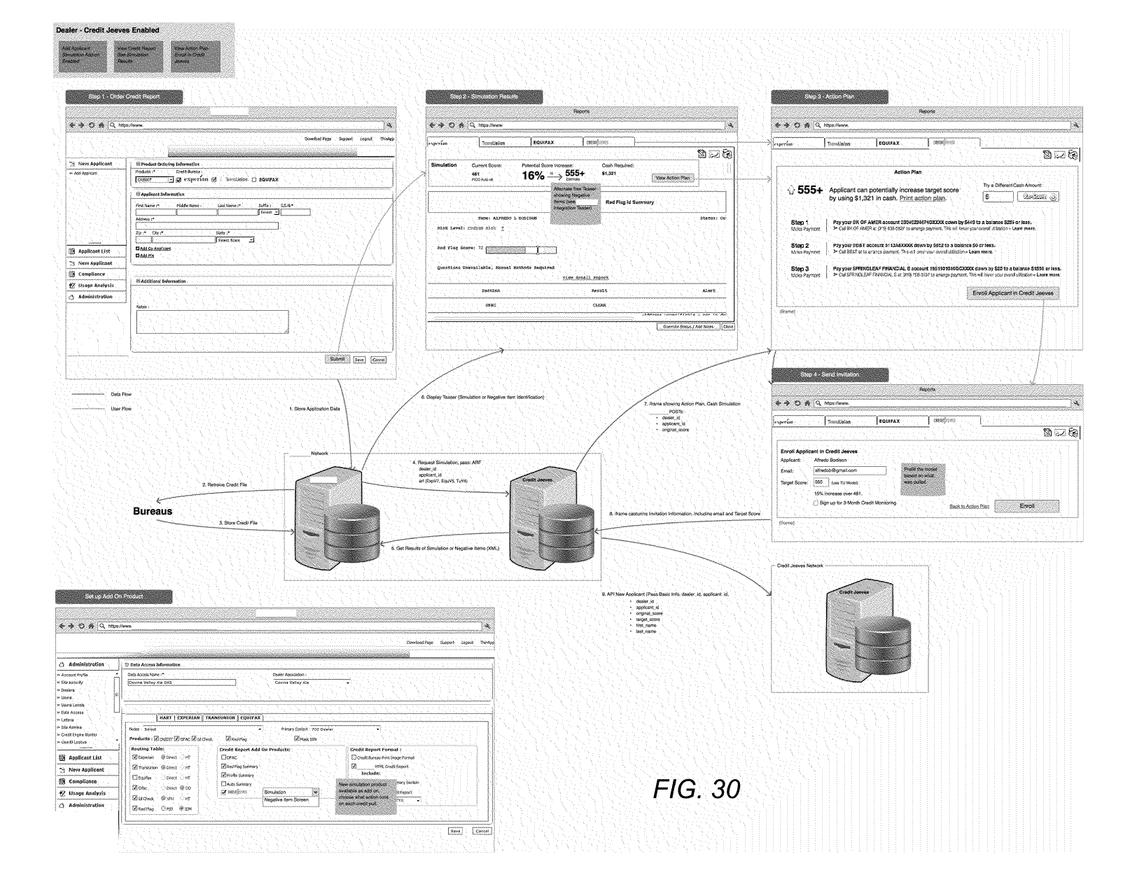

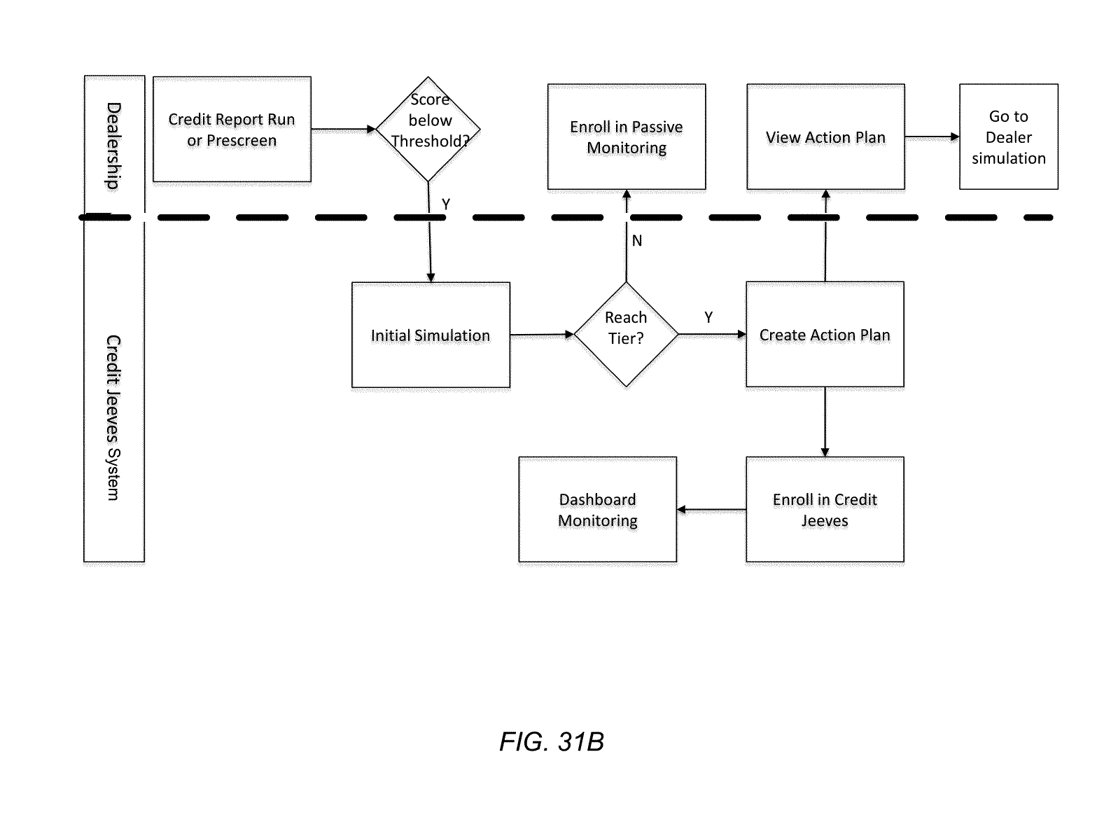

FIG. 30 outlines data movement within a system according to some embodiments of the invention. A data movement perspective between a dealership process and system and the Credit Jeeves process including all four process steps and scenarios described above with regard to FIG. 32; Dealership Enrollment, Threshold Simulation & Optimization, Dealers Simulation & Consumer Review, Credit Jeeves Enrollment is shown. In this process, the dealerships can automate the generation of threshold simulation or request based on various parameters such as credit score/tiers, stated income, deal equity, or others as determined by individual dealerships to determine when they will leverage the services. Upon seeing the max potential (or range) with a percent increase the dealer can decide to enroll the consumer, view the specific action plan to achieve the max potential, or not leverage the information. If dealer decides to view an action plan, the dealer can further simulate based on Simulation Engines (Described in diagrams and figures above, such as cash, challenge, credit limit, etc.). Consumers can potentially take immediate action as described in the Instascore process or follow the standard process flow and reconnect when reaching target score.

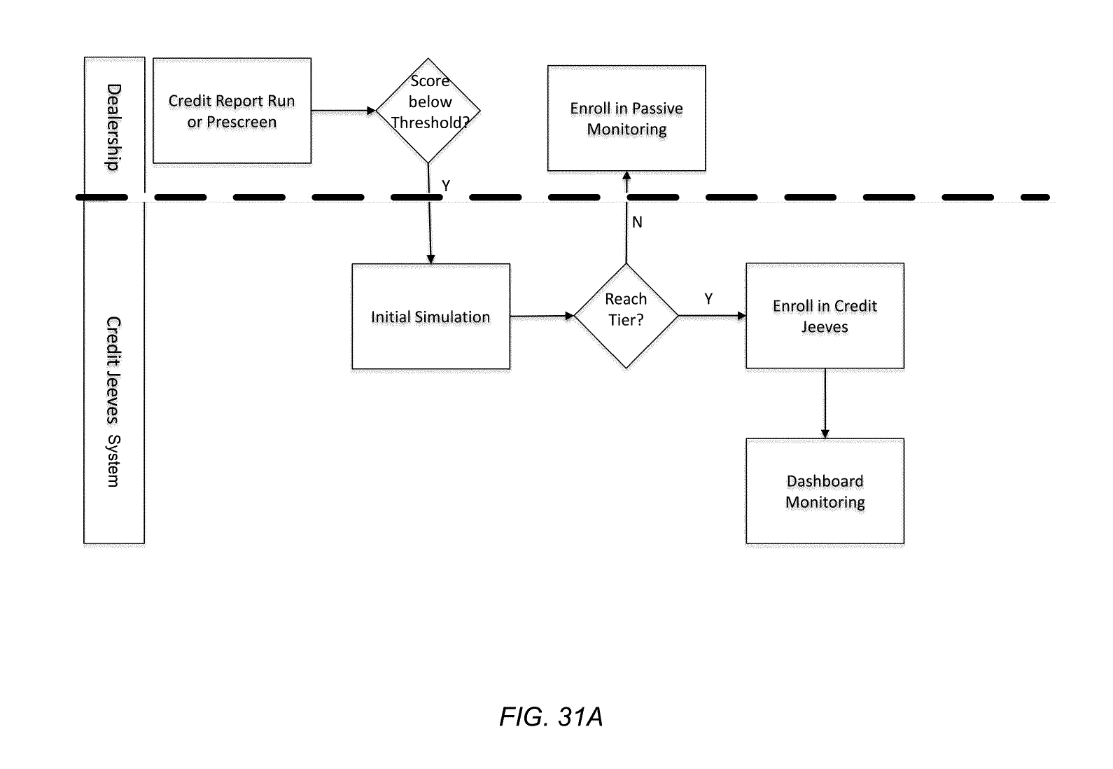

FIG. 31A is a process-flow diagram illustrating steps of a credit threshold simulation including a dealer simulation according to some embodiments of the invention.

FIG. 31B is a process-flow diagram illustrating steps of a credit threshold simulation according to some embodiments of the invention.

The initial simulation is meant to provide the dealer with a guide to the following criteria to determine the best course of action for the dealer and the consumer. This empowers both the consumer and dealer to collaborate and determine the optimum approach. The questions and criteria to address can include:

Can consumer reach target and/or next tier? The initial dashboard summarizes the current score, percent score increase, and summarized overview of what is required to achieve a target or next tier

What is their max potential score?—If there is not a specific target, or if the dealer, consumer want to see Threshold Simulation on the max potential score they can choose to view at this step. This applies to consumers who may qualify for tiers higher than a standard goal or multiple tiers higher to potentially qualify for even lower interest rates.

Ability to reach?—Qualify Potential can be provided which is a measurement, described in detail previously in Dealer Dashboard section, of likelihood a consumer can reach a desired target. It can also be a qualitative assessment between the consumer and dealer once they progress to the next step of viewing the Action Plan steps

Gross if they reach?—Rate Card can be provided which is a measurement, described in detail previously in Dealer Dashboard section, of potential gross by lending tier the dealer can achieve if they are able to finance the consumer through various lending channels they have access too.

FIG. 32 is a process-flow diagram outlining Dealer Simulation & Consumer Review steps according to some embodiments of the present invention. Progressing to dealer simulation enables dealer and the consumer to view the potential steps to achieve the desired target. Note this is similar to the ‘Coaching’ process flow described previously. This step also enables the dealer and consumer to use the Simulation Engines to view alternative goals and plans including different tiers, max scores, best use of cash, challenging tradelines, etc. This empowers both the consumer and dealer to collaborate and determine the optimum approach. The questions, criteria to address include:

View actions steps by credit tier. The specific steps and score impact are provided and can be altered based on various goals or simulations ran.

Ability to reach?—This can be a quantitative and qualitative assessment between the consumer and dealer (or just the consumer) beyond the Qualify Potential that enables the consumer to view steps and assess;

Do I have the cash to perform a given step or steps?

Has this step already been taken? Such as balances already paid, late payments already addressed (paid, challenged), limits already changed.

Are there inaccuracies in my report?

Willing to reach? If the consumer may have already taken a step or is willing to take a step immediately (e.g. dispute an inaccuracy, pay down a late payment, pay off a collection, increase credit limit, consolidate, etc) that can be done immediately and potentially facilitated by the dealer/lender.

View Qualify Potential by credit tier? Additional simulations may uncover alternative plans and steps with higher or lower Qualify Potential.

View gross by credit tier? Dealers can determine the implications of potentially making more gross on a particular sale based on a variety of these considerations.

### RentTrack System

Currently consumers searching for apartments do not have the ability to apply once and send to multiple landlords, nor do landlords have the ability to accept background check data from consumers in a secure fashion. Consumers first must apply for a rental property, pay a fee, before they or the landlord have any visibility into if they will qualify. The majority of Landlords have Scorecards they use filter applicants based on a variety of income, credit, criminal, and eviction data.

In addition, consumers are not able to use or see the impact of paying rent and how that impacts their creditworthiness via their score and history.

Currently landlords, large and small, have a high cost to accept, process, and review online rental applications, background checks, and rent payments among the many costs of doing business. Landlords must deal with unqualified rental applicants, delinquent rent payments, manually processing of payment types, as well as with new or uneducated tenants unaware of the importance of on time payments. There is a high cost and compliance barrier to accepting payments as a merchant.

Thus the process and rental application to payment cycle is highly disconnected for both renters and landlords.

RentTrack has designed and built a process that delivers a solution for these tenant and landlord challenges via a single system delivered as a service:
Tenants search for rentals and apply filters with pre-qualifying rental criteria to show only those rentals which you qualify for.
Tenants set up prescreened alerts to learn when new qualified rentals are available.
Tenants send a single rental application and credit/background report to multiple landlords with significant time and cost savings for all involved.
Deliver landlords prequalified applicants rather than unknown applicants.
Landlords sign up for a merchant account using Frictionless and Paperless Onboarding to minimized risk, cost, and reduce compliance requirements.
Tenant builds credit with rental payments and has full visibility into credit profiles with action plans to achieve credit and financial goals.
Tenant rental payment history incorporated into process to qualify tenant for next landlord.

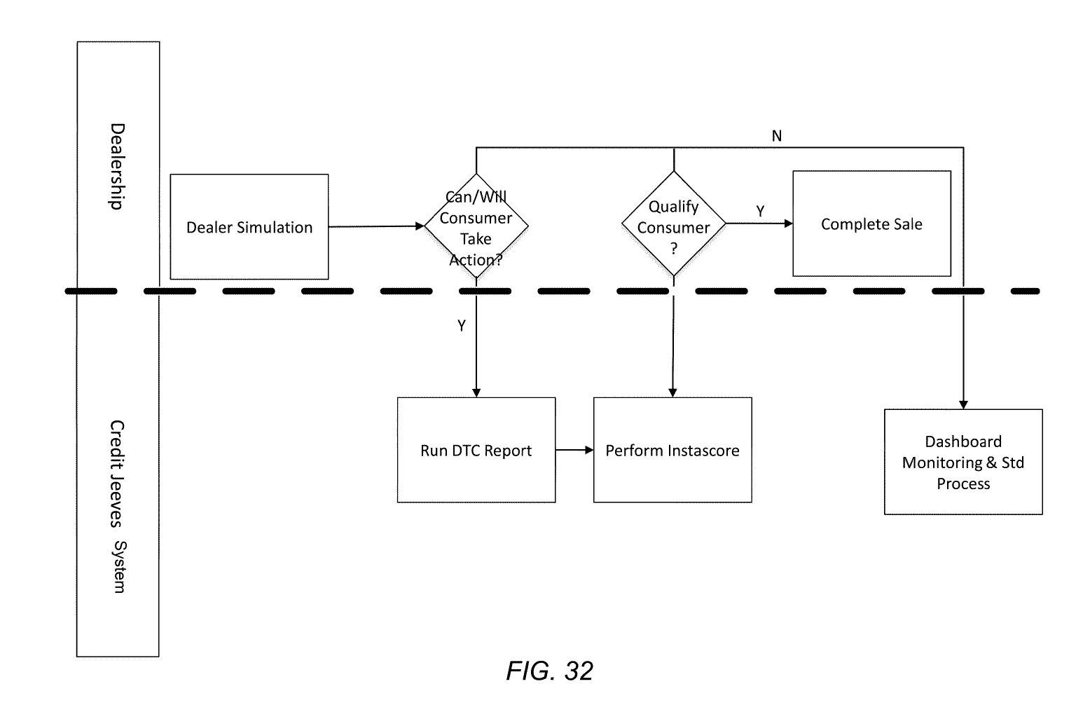

FIG. 33 is a process-flow diagram outlining steps in a High Level Tenant Credit Process, from End to end, with flow beginning at enrollment according to some embodiments of the invention. Applicant enrollment can start either as existing renters for landlords already clients of RentTrack, or for any renter who applies directly on the RentTrack portal.

RentTrack Connect enables applicants to integrate their credit report, and background checks into the application process to filter by landlord's specific rental criteria and potentially prequalify or get alerted to red flags prior to applying for properties. The process also enables the pre-filling of as many rental applications as the renter chooses.

RentTrack Connect helps applicant order specific permissible purpose credit reports and background checks (that are accepted by all landlords) once and sends with completed rental applications. If applicants are accepted, it integrates the leasing and payment setup with enrollment.

Applicant Goal Setting enables consumers to set any credit or financial goals, potentially derived from falling short of certain landlord rental criteria. See Credit Jeeves process for details.

Rental Payments Recording and Reporting connect the rent payment history to the credit profile and score to both establish and build credit history for consumers, integrating them to with their credit and financial goals. Furthermore, the payment history can be used in future screening for Tenant's next rental.

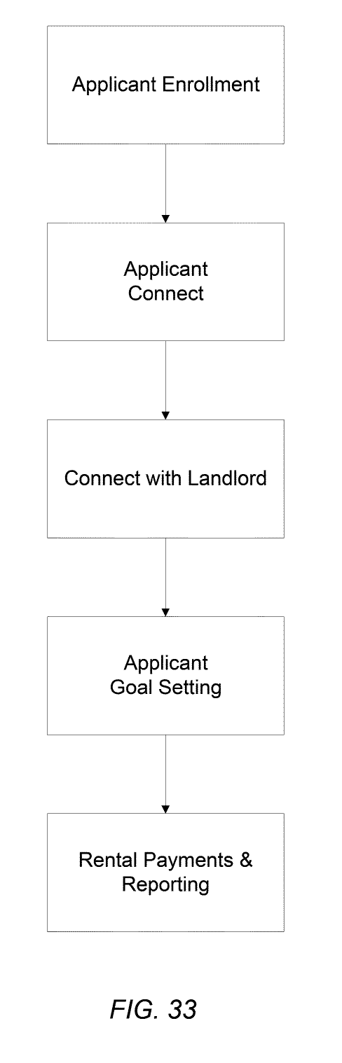

FIG. 34 is a system block-flow diagram illustrating a RentTrack Connect process according to some embodiments of the invention.

Differentiating Capabilities of RentTrack Connect—

No other process is known to integrate prequalification of rent to rental scorecards with background checks to facilitate the applicant to landlord search and application process. By building in the prequalification filter applicants are alerted to specific criteria in their income, credit, criminal or eviction data that may disqualify them from rent and then automates those alerts into specific credit or financial goals with an action plan.

Landlord Scorecard Filter—

RentTrack maintains Scorecards for all landlords that are clients. Scorecards are based on common credit report and background criteria landlords use to evaluate applicants such as Historical Late or Missed Rental Payments, Risk Score Range, Income to Debt Ratio, Income to Rent Ratio, Delinquent Accounts (by time range, current, all), Charge-Offs/Collections (including all account types like Medical Payments, revolving or installment loans), Public Records such as bankruptcies, and criminal and eviction data.

Applicants can still choose to apply to a property if the landlord has configured their property to accept filtered applicants even after the Scorecard filter has been run, Landlords who have Scorecards will be notified prior to accepting the application of the results in the event they want to facilitate a streamlined rental application review process (e.g. if they have multiple applications they are considering they can choose to ignore, filter any applicant that has applied and not pre-qualified).

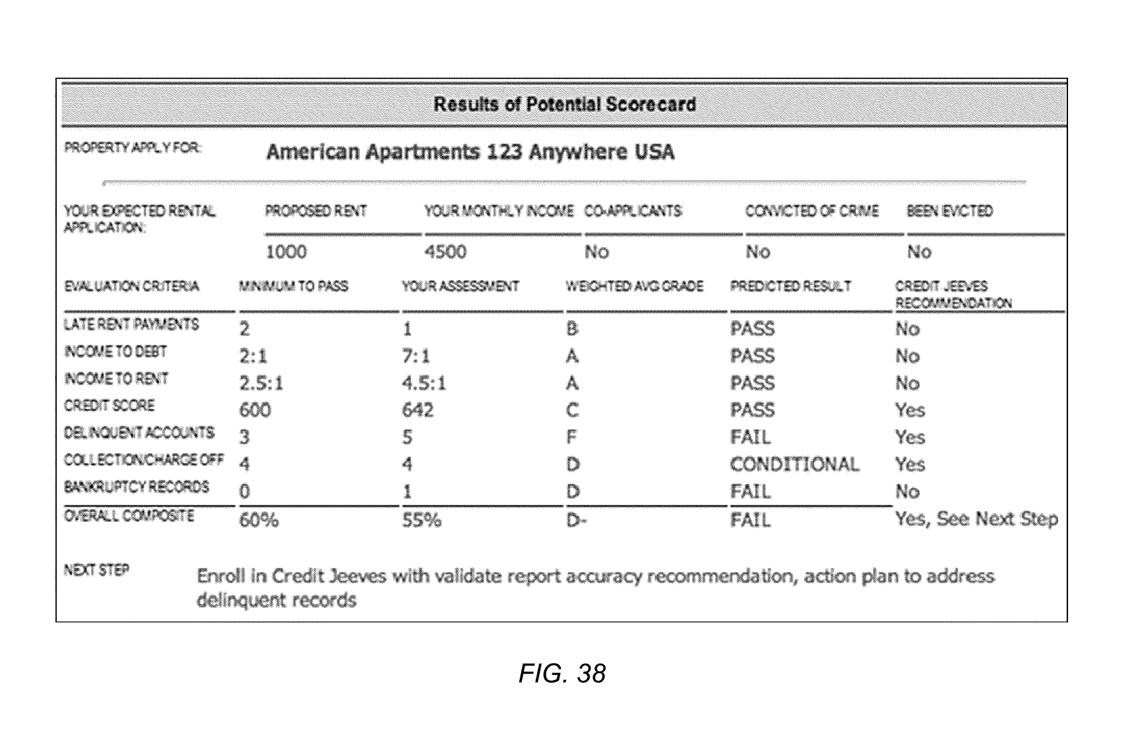

FIG. 38 is a table showing an example of what an applicant would see for the property or set of properties they were applying for.

In addition, RentTrack has built a Landlord Association Algorithm (LAA) based on a variety of geographic, business, and related property attributes that is used to generate ‘mock’ Scorecards for properties where RentTrack does not have an actual Scorecard.

LAA weights three categories for all properties without Scorecards to find the closest 3 matches to existing properties with Scorecards: Geographic location, Property Attributes (type of units, # of units, average rent, size of units, amenities), Posted Availability (vacancy). Those matches are averaged and applied to a ‘mock’ Scorecard to use to help assess if applicants will pass rental criteria. This does not limit or preclude applicants but is meant to optimize their time and money in finding and applying for properties.

Rentability Metrics—

RentTrack integrates the Applicant filter criteria, Applicant Rental Report with the Landlord Scorecard filter to generate a Rentability Score per property.

In addition, RentTrack may suggest additional properties for Applicants to consider (if either Applicant requested recommendation or the returned properties were lower than threshold)

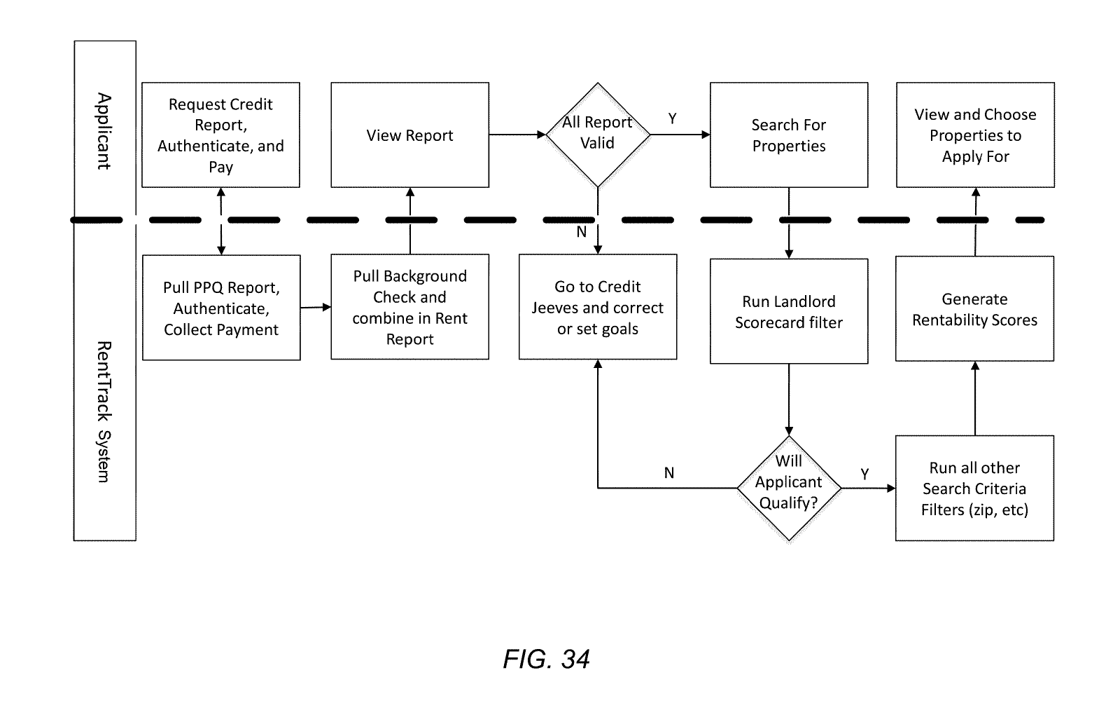

FIG. 35 is an exemplary system block-flow diagram illustrating a connection between an applicant and a landlord per some embodiments.

Applying for Properties—

When applying for properties that are already clients of RentTrack, RentTrack will be able to prefill online applications with applicant data reducing the time spent and processing for both the applicant and landlord. The applicant will not need to pay for multiple reports and background checks, instead they will be able to reuse their information multiple times.

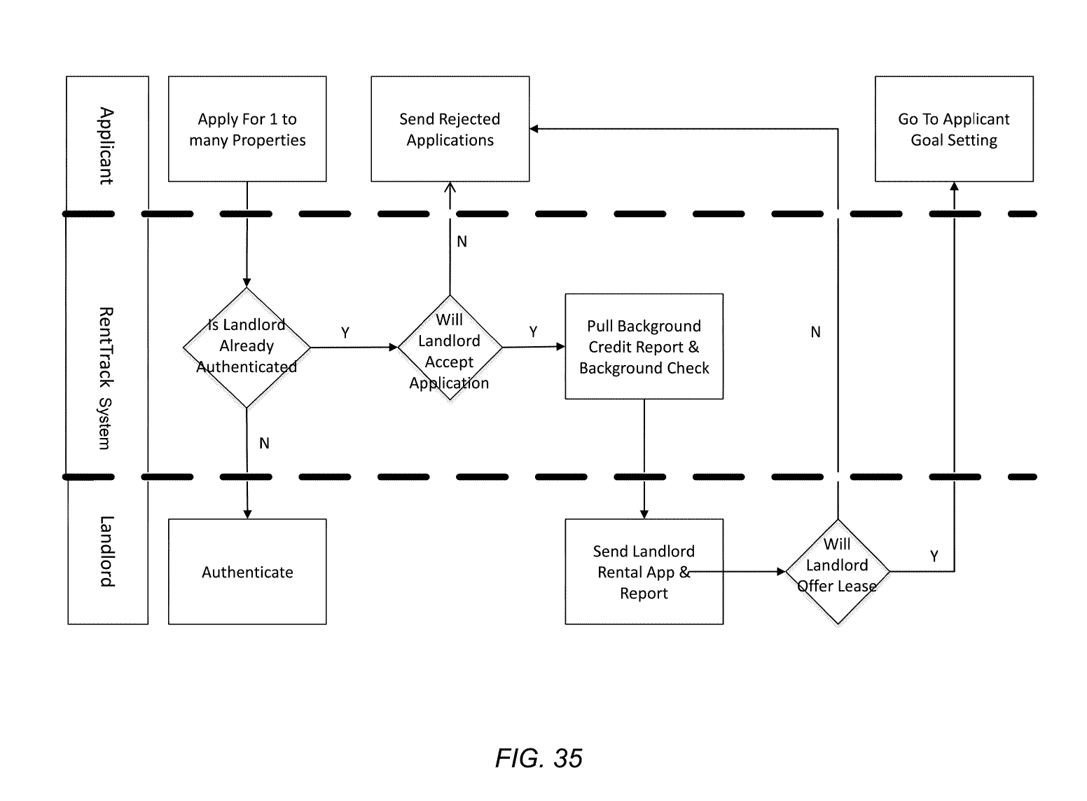

FIG. 36 is a process flow diagram outlining a High Level Landlord Process Flow according to some embodiments.

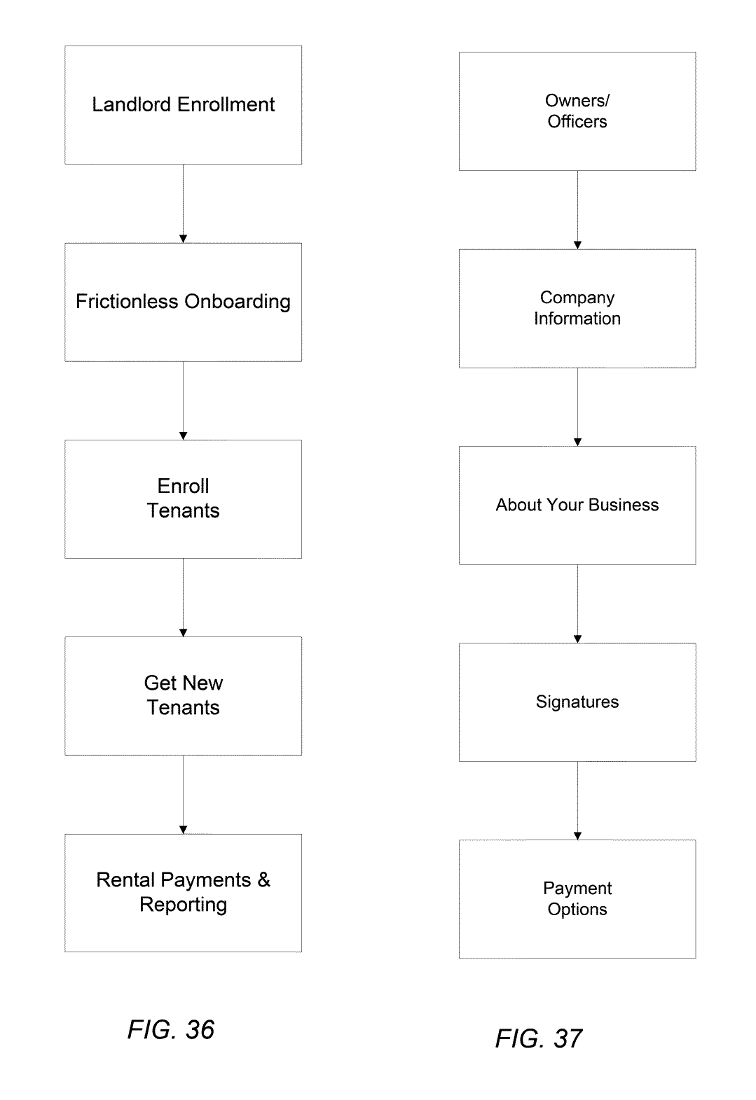

FIG. 37 is a process flow diagram outlining the process of Frictionless Onboarding as shown in FIG. 36.

Overview of Frictionless Onboarding—

Two types of Merchant Processing are supported today for property managers. They are direct merchants of a payment processor or Third Party Sender (First Data, Profit Stars) and have to follow all compliance (PCI, NACHA), costs, and complexity with merchant setup and usage. This requires a significant amount of setup, paperwork, long underwriting processes all done manually. It typically provides much lower transactional costs and direct deposit into their accounts versus stopping at third party aggregator in between, but at the expense of higher risk, both from fraud and compliance.

They are clients of Payment Providers, ISVs, aggregators (such as Paypal or other Property Management Software companies) that accept payments on their behalf. This requires less setup for landlords, no compliance overhead, and the reduced risk of fraud or chargebacks. However, it requires the deposit of rent into a third party account until payments have cleared and been aggregated—longer time. It also has a higher cost and risk for the Payment Providers, which is passed on to the landlords as high transactional costs.

In an ideal world, landlords would be able to enjoy the benefits of both without the drawbacks of either. Meaning an easy, seamless setup to accept online payments, payments made directly into their accounts, reduced risk of fraud or chargeback payments, all lower transactional costs.

RentTrack is the first company to bring a unique hybrid model that is similar to a common Third-Party Service Provider Model that integrates the benefits of both models. RentTrack accomplishes this by being a Merchant of Record for payment processors and allowing landlords to become sub-merchants. Thus RentTrack is the only entity that needs to follow the compliance of the Payment Card Industry, pays all of the compliance fees of processing, covers the risk of NSF, chargebacks, deposits funds directly from tenants into landlords accounts.

That means RentTrack takes on all the risk, pays for the cost of the risk, allows sub-merchants hassle free, seamless set up merchant accounts all online, providing all online payment types.

RentTrack partners closely and fully integrates with payment processors for setup and payment to facilitate the process, spread the risk and cost, thus providing a seamless experience for landlords.

Differentiating Capabilities—

Consumers can find properties to rent, apply for one to many properties, pull their full credit report, RT augments national eviction and criminal search to share with landlords, filters reports based on identified or calculated Rental Criteria (Scorecards), then securely shares those records as part of the rental application process. This saves time and money for the applicant (via filtering out properties they will not qualify for, reduced application fees because the credit report and background check are shared, less time via prefilled applications for existing RentTrack properties), landlord (receives only applications that already pass rental criteria, reduced processing time for landlords by filling out applications for tenants). This enables the renters to find and apply for properties where they already pass a landlords rental criteria (via the Background Scorecard filter). This alerts applicants to why they would not pass (e.g. debt to income ratio too high) and enables them via Credit Jeeves to set goals, get an action plan, and eventually qualify.

RentTrack integrated with Credit Jeeves capabilities enables tenants to prequalify for potential properties or be alerted with an goal and action plan if they will or do not qualify, report rent to build history, track their rent history, and tie it to their credit score and history. This raises the awareness of renters (and consumers in general), creates more transparency in credit, and ties it together credit education with credit and financial goal setting with actionable plans.

Landlord frictionless boarding providing minimized risk, cost, and compliance of merchant payment processing with the benefits of low cost of accepting payments.

Enabling renters to connect a single report to many landlords integrated into rent reporting and score monitoring leveraging rent data.

Encourage on time payments with rent history and credit score visibility.

Landlords can reduce their rent payment costs to zero when their tenants sign up for Credit Jeeves services.

Landlords can earn a revenue share when their tenants sign up for financial referrals (credit cards, auto loans, etc.).

Landlords can reference payment history of long-standing RentTrack tenants during application process, providing additional information the Landlord can use to screen tenant that they would not be able to secure easily otherwise.

System Physical Configurations—

Turning now to FIG. 27, the figure shows a high-level block diagram of a credit processing system 600 according to some embodiments of the invention.

Various components of embodiments of systems, methods and devices for processing consumer credit data, including modifying consumer credit data and for automated monitoring, modeling, simulation and engagement for transaction recapture may be embodied in a credit processing system such as system 600 that includes a combination of hardware, software, and/or firmware, and which may interact with various other devices. One such credit processing system is illustrated by FIG. 27. In the illustrated embodiment, credit processing system 600 includes one or more processors 610 coupled to a system memory 620 via an input/output (I/O) interface 630. Credit processing system 600 further includes a network interface 640 coupled to I/O interface 630, and one or more input/output devices 650, such as cursor control device 660, keyboard 670, audio device 690, and display(s) 680. In some embodiments, it is contemplated that embodiments may be implemented using a single instance of credit processing system 600, while in other embodiments multiple such systems, or multiple nodes making up credit processing system 600, may be configured to host different portions or instances of embodiments. For example, in one embodiment some elements may be implemented via one or more nodes of credit processing system 600 that are distinct from those nodes implementing other elements.

In various embodiments, credit processing system 600 may be a uniprocessor system including one processor 610, or a multiprocessor system including several processors 610 (e.g., two, four, eight, or another suitable number). Processors 610 may be any suitable processor capable of executing instructions. For example, in various embodiments, processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA.

In some embodiments, at least one processor 610 may be a graphics processing unit. A graphics processing unit or GPU may be considered a dedicated graphics-rendering device for a personal computer, workstation, game console or other computer system. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for a system, method and device for automated monitoring, modeling, simulation and engagement for transaction recapture may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 620 may be configured to store program instructions and/or data accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a system, method and device for automated monitoring, modeling, simulation and engagement for transaction recapture, are shown stored within system memory 620 as program instructions 625 and data storage 635, respectively. In other embodiments, program instructions and/or data may be received, sent or stored upon different types of computer-accessible media or on similar media separate from system memory 620 or credit processing system 600. Generally speaking, a computer-accessible medium may include storage media or memory media such as magnetic or optical media, e.g., disk or CD/DVD-ROM coupled to credit processing system 600 via I/O interface 630. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 640.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. In addition, in some embodiments some or all of the functionality of I/O interface 630, such as an interface to system memory 620, may be incorporated directly into processor 610.

Network interface 640 may be configured to allow data to be exchanged between credit processing system 600 and other devices attached to a network, such as other computer systems, or between nodes of credit processing system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or retrieving data by one or more credit processing system 600. Multiple input/output devices 650 may be present in credit processing system 600 or may be distributed on various nodes of credit processing system 600. In some embodiments, similar input/output devices may be separate from credit processing system 600 and may interact with one or more nodes of credit processing system 600 through a wired or wireless connection, such as over network interface 640.

As shown in FIG. 27, memory 620 may include program instructions 625, configured to implement embodiments of a system, method and device for automated monitoring, modeling, simulation and engagement for transaction recapture, and data storage 635, comprising various data accessible by program instructions 625, for example a system and/or method for automated monitoring, modeling, simulation and engagement for transaction recapture. In one embodiment, program instructions 625 may include software elements of a system or method for automated monitoring, modeling, simulation and engagement for transaction recapture as illustrated in the above Figures. Data storage 635 may include data that may be used in embodiments, for example one or more files containing program instructions for a method of automated monitoring, modeling, simulation and engagement for transaction recapture. In other embodiments, other or different software elements and/or data may be included.

Those skilled in the art will appreciate that credit processing system 600 is merely illustrative and is not intended to limit the scope of a system, method and device for automated monitoring, modeling, simulation and engagement for transaction recapture as described herein. In particular, the credit processing system and devices may include any combination of hardware or software that can perform the indicated functions, including computers, network devices, internet appliances, PDAs, wireless phones, pagers, etc. Credit processing system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated credit processing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from credit processing system 600 may be transmitted to credit processing system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other credit processing system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc.

The various methods as illustrated in the Figures and described herein represent examples of embodiments of methods. The methods may be implemented in software, hardware, or a combination thereof. The order of method may be changed, and various elements may be added, reordered, combined, omitted, modified, etc.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A method for modifying a consumer's credit data, comprising:
receiving, with processing circuitry, consumer data identifying a consumer;
receiving, with the processing circuitry, at least one credit goal;
retrieving, with the processing circuitry, credit tradeline data using the consumer data, the credit tradeline data associated with at least one credit tradeline of the consumer;
simulating, with the processing circuitry, one or more changes to the credit tradeline data to generate a corresponding simulation;
determining, with the processing circuitry, whether the simulation achieves the at least one credit goal; and
generating an action plan with the processing circuitry, the action plan comprising one or more steps for the consumer to achieve the at least one credit goal;
wherein the one or more steps comprise making the one or more changes corresponding to the simulation if the simulation achieves the at least one credit goal.

2. The method of claim 1, further comprising receiving a selection of one of the steps of the action plan and at least partially completing the selected step with the processing circuitry on behalf of the consumer.

3. The method of claim 1, further comprising:
generating an enrollment interface in association with a consumer credit event having a negative outcome, the enrollment interface configured to receive the consumer data;
wherein the at least one credit goal comprises changing the negative outcome; and
wherein the one or more steps of the action plan generated with the processing circuitry are configured to change the credit tradeline data such that a subsequent instance of the consumer credit event has a positive outcome.

4. The method of claim 3, wherein the consumer credit event comprises an application for credit by the consumer, the negative outcome comprises a denial of the application for credit, the consumer data comprises information that identifies the consumer, the credit tradeline data comprises a credit score for the consumer, the at least one credit goal comprises improving the credit score to change the negative outcome, and wherein the positive outcome comprises an approval of the application for credit.

5. The method of claim 4, further comprising:
monitoring the credit score with the processing circuitry;
detecting, with the processing circuitry, improvement in the credit score sufficient to change the negative outcome; and
notifying, with the processing circuitry, a lender that the at least one credit goal has been achieved.

6. The method of claim 4, further comprising:
receiving the consumer data and the at least one credit goal, with the processing circuitry, from a lender offering the application for credit;
monitoring the credit score with the processing circuitry;
detecting, with the processing circuitry, improvement in the credit score sufficient to change the negative outcome; and
notifying, with the processing circuitry, the lender that the at least one credit goal has been achieved.

7. The method of claim 4, further comprising:
simulating, with the processing circuitry, a range of the one or more changes to the credit tradeline data;
generating, with the processing circuitry, a trend line of credit scores associated with the range of changes;
determining, with the processing circuitry, a portion of the trend line and a corresponding subset of the range of changes that achieve the at least one credit goal of changing the negative outcome; and
selecting, with the processing circuitry, one of the subset of changes according to a selection criteria.

8. The method of claim 7, wherein the one or more changes to the credit tradeline data comprise lowering a credit account balance and/or increasing an amount of credit available to the consumer.

9. The method of claim 7, wherein the selection criteria comprises optimal impact.

10. The method of claim 1, further comprising:
generating, with the processing circuitry, an enrollment interface, the enrollment interface configured to receive the consumer data;
wherein the at least one credit goal comprises one or more of buying a house, buying a car, consolidating credit accounts, lowering a credit account balance, lowering a credit account payment, building a positive credit profile, and protecting the consumer's credit.

11. A method for modifying a consumer's credit data, comprising:
generating, with a credit processing system comprising processing circuitry, an enrollment interface configured to receive consumer data comprising information that identifies a consumer;
transmitting, with the credit processing system, the enrollment interface for display to the consumer in association with an undesirable credit event with a lender;
receiving from the enrollment interface, with the credit processing system, the consumer data and at least one credit goal associated with the undesirable credit event, the at least one credit goal comprising transformation of the undesirable credit event to a desirable credit event;
retrieving, with the credit processing system, credit tradeline data for the consumer using the consumer data, the credit tradeline data associated with at least one credit tradeline of the consumer;
simulating, with the credit processing system, one or more changes to the credit tradeline data to generate a corresponding simulation;
determining, with the credit processing system, whether the simulation achieves the at least one credit goal;
generating an action plan with the credit processing system, the action plan comprising one or more steps for the consumer to achieve the at least one credit goal, the one or more steps comprising making the one or more changes corresponding to the simulation if the simulation achieves the at least one credit goal;
monitoring the credit tradeline data with the credit processing system;
detecting from the credit tradeline data, with the credit processing system, if the at least one credit goal is achieved; and
notifying, with the credit processing system, the lender that the at least one credit goal has been achieved.

12. The method of claim 11, wherein the undesirable credit event comprises a denial of an application for credit by the consumer;
wherein the credit tradeline data comprises a credit score for the consumer;
wherein the at least one credit goal comprises improving the credit score to transform the undesirable credit event to the desirable credit event; and
wherein the desirable credit event comprises an approval of an application for credit by the consumer.

13. A credit processing system, comprising:
processing circuitry, the processing circuitry comprising one or more processors and a data memory module coupled to the one or more processors, the data memory module comprising instructions executable by the one or more processors that upon execution cause the one or more processors to:
generate, with the processing circuitry, an enrollment interface in association with an undesirable credit event for a consumer, the enrollment interface configured to receive one or more credit goals and consumer data comprising information that identifies the consumer;
receive from the enrollment interface, with the processing circuitry, the consumer data and at least one credit goal associated with the undesirable credit event, the at least one credit goal comprising transformation of the undesirable credit event to a desirable credit event;
retrieve, with the processing circuitry, credit tradeline data for the consumer using the consumer data, the credit tradeline data associated with at least one credit tradeline of the consumer;
simulate, with the processing circuitry, one or more changes to the credit tradeline data to generate a corresponding simulation;
determine, with the processing circuitry, whether the simulation achieves the at least one credit goal;
generate an action plan with the processing circuitry, the action plan comprising one or more steps for the consumer to achieve the at least one credit goal, the one or more steps comprising making the one or more changes corresponding to the simulation if the simulation achieves the at least one credit goal;
monitor the credit tradeline data with the processing circuitry,
detect from the credit tradeline data, with the processing circuitry, if the at least one credit goal is achieved; and
notify a lender, with the processing circuitry, that the at least one credit goal has been achieved.

14. The system of claim 13, wherein the instructions further cause the one or more processors to transmit the enrollment interface for display to the consumer in association with the undesirable credit event occurring with the lender.

15. The system of claim 14, wherein the credit tradeline data comprises a credit score for the consumer;
wherein the at least one credit goal comprises improving the credit score to transform the undesirable credit event to the desirable credit event; and
wherein the undesirable credit event comprises a denial of an application for credit for the consumer; and
wherein the desirable credit event comprises an approval of an application for credit for the consumer.

16. The system of claim 15, wherein the instructions further cause the one or more processors to receive a selection of one of the steps of the action plan and to at least partially complete the selected step with the processing circuitry on behalf of the consumer.

17. The system of claim 15, wherein the instructions further cause the one or more processors to:
simulate, with the processing circuitry, a range of the one or more changes to the credit tradeline data;
generate, with the processing circuitry, a trend line of credit scores associated with the range of changes;
determine, with the processing circuitry, a portion of the trend line and a corresponding subset of the range of changes that achieve the at least one credit goal comprising the transformation of the undesirable credit event to the desirable credit event; and
select, with the processing circuitry, one of the subset of changes according to a selection criteria.

18. The system of claim 17, wherein the selection criteria comprises optimal impact.

19. The system of claim 18, wherein the one or more changes to the credit tradeline data comprise lowering a credit account balance and/or increasing an amount of credit available to the consumer.

20. The system of claim 13, wherein the undesirable credit event comprises a negative credit determination by the consumer; and
wherein the at least one credit goal comprises one or more of buying a house, buying a car, consolidating credit accounts, lowering a credit account balance, lowering a credit account payment, building a positive credit profile, and protecting the consumer's credit.
